(19) United States
(12) Patent Application Publication
(10) Pub. No.: US 2023/0073140 A1
(43) Pub. Date: Mar. 9, 2023

(54) SYSTEMS AND METHODS FOR DATA AGGREGATION FOR TRANSACTION SETTLEMENT

(71) Applicant: Worldpay, LLC, Symmes Township, OH (US)

(72) Inventors: Bernd RICHTER, Pronstorf (DE); Michael BURGESS, Hertfordshire (GB); Andrew HEWITT, West Yorkshire (GB)

(21) Appl. No.: 17/700,125

(22) Filed: Mar. 21, 2022

Related U.S. Application Data
(60) Provisional application No. 63/260,885, filed on Sep. 3, 2021.

(51) Int. Cl. G06Q 20/02; G06Q 20/40

(52) U.S. Cl. CPC G06Q 20/027; G06Q 20/4014

(57) ABSTRACT

Systems and methods are disclosed for data aggregation and efficient routing of the aggregated data for the settlement of payments. The method includes receiving, in real-time, transactions associated with an account of a registered user. The outstanding amount associated with transactions is aggregated based on a first preset time period. The payments for the aggregated outstanding amount are transmitted from a settlement account to an account of a merchant based on the first preset time period and/or a pre-determined total outstanding amount threshold. The transmitted payments are aggregated based on a second preset time period. The amount equivalent to the aggregated transmitted payments is transmitted from the account associated with the registered user to the settlement account based on the second preset time period. A user interface is then generated in devices of the registered user and merchant.

### CROSS-REFERENCE TO RELATED APPLICATION(S)

This patent application claims the benefit of priority to U.S. Provisional Patent Application No. 63/260,885, filed on Sep. 3, 2021, the entirety of which is incorporated herein by reference.

### TECHNICAL FIELD

The present disclosure relates generally to the field of payment transactions and, more particularly, to systems and methods for settlement of payments between bank accounts associated with a consumer and a merchant.

### BACKGROUND

Traditionally, merchants have point of sale (POS) terminals and POS systems that accept payments from consumers for goods and services rendered. Merchants typically contract an acquirer to process the payment transactions originating from the merchant's POS terminals and POS systems. The acquirer processors process the payment transactions and settle funds between consumers' and merchants' accounts. However, such processing methods rely on complex communications among multiple entities in order to process a transaction without taking advantage of ubiquitous modern technology infrastructure.

Typically, the acquirer processors charge substantial fees to the merchants for processing each payment card transaction. A large portion of these high fees may be pass-through fees from the card-issuing banks, e.g., interchange fees, and the card networks, e.g., assessment fees. Furthermore, timing is important to merchants and they may prefer to receive payments from the consumers as soon as possible, but the complex communication channels that involve acquirer processors delay the payment delivery.

Consumers may prefer the convenience of payment by the payment card because the fees are not directly reflected in the cost of the items being purchased. Though invisible to consumers, the pass-through fees burden the consumers by indirectly increasing the cost of goods and services. In addition, consumers may prefer the payments for goods and services to be delayed so that they have the freedom to pay over time without the need to obtain credit.

Accordingly, there is a need for systems and methods for data aggregation and efficient routing of the aggregated data for the settlement of payments.

### SUMMARY OF THE DISCLOSURE

According to certain aspects of the disclosure, systems and methods are disclosed for providing configuration parameters in a streamlined manner so that developers can construct end-to-end solutions in an automated manner.

In one embodiment, a method is disclosed for data aggregation and efficient routing of the aggregated data for the settlement of payments. The method includes: receiving, in real-time, a plurality of transactions associated with an account of a registered user; aggregating outstanding amount associated with the plurality of transactions based, at least in part, on a first preset time period; transmitting payments for the aggregated outstanding amount from a settlement account to an account associated with a merchant to the plurality of transactions based, at least in part, on the first preset time period, a pre-determined total outstanding amount threshold, or a combination thereof; aggregating the transmitted payments based, at least in part, on a second preset time period; transmitting an amount that equals the aggregated transmitted payments from the account associated with the registered user to the settlement account based, at least in part, on the second preset time period; and generating a user interface element in a user interface of a device associated with the registered user, the merchant, or a combination thereof.

In one embodiment, an apparatus comprises at least one processor, and at least one memory including computer program code for one or more computer programs, the at least one memory and the computer program code configured to, with the at least one processor, cause, at least in part, the apparatus to aggregate data and efficiently route the aggregated data for the settlement of payments. The apparatus causes: receive, in real-time, a plurality of transactions associated with an account of a registered user; aggregate outstanding amount associated with the plurality of transactions based, at least in part, on a first preset time period; transmit payments for the aggregated outstanding amount from a settlement account to an account associated with a merchant to the plurality of transactions based, at least in part, on the first preset time period, a pre-determined total outstanding amount threshold, or a combination thereof; aggregate the transmitted payments based, at least in part, on a second preset time period; transmit an amount that equals the aggregated transmitted payments from the account associated with the registered user to the settlement account based, at least in part, on the second preset time period; and generate a user interface element in a user interface of a device associated with the registered user, the merchant, or a combination thereof.

In accordance with another embodiment, a non-transitory computer-readable storage medium having stored thereon one or more program instructions which, when executed by one or more processors, cause, at least in part, an apparatus to aggregate data and efficiently route the aggregated data for the settlement of payments. The apparatus causes: receiving, in real-time, a plurality of transactions associated with an account of a registered user; aggregating outstanding amount associated with the plurality of transactions based, at least in part, on a first preset time period; transmitting payments for the aggregated outstanding amount from a settlement account to an account associated with a merchant to the plurality of transactions based, at least in part, on the first preset time period, a pre-determined total outstanding amount threshold, or a combination thereof; aggregating the transmitted payments based, at least in part, on a second preset time period; transmitting an amount that equals the aggregated transmitted payments from the account associated with the registered user to the settlement account based, at least in part, on the second preset time period; and generating a user interface element in a user interface of a device associated with the registered user, the merchant, or a combination thereof.

Additional objects and advantages of the disclosed embodiments will be set forth in part in the description that follows, and in part will be apparent from the description, or may be learned by practice of the disclosed embodiments. The objects and advantages on the disclosed embodiments will be realized and attained by means of the elements and combinations particularly pointed out in the appended claims.

It is to be understood that both the foregoing general description and the following detailed description are exemplary and explanatory only and are not restrictive of the detailed embodiments, as claimed.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram of a system capable of data aggregation and efficient routing of the aggregated data for payment settlement, according to one example embodiment;

FIG. 2 is a diagram of the components of transaction processing system 109, according to one example embodiment;

FIG. 3 is a diagram of the sub-components of the components in FIG. 2, according to one example embodiment;

FIG. 4 is an architectural diagram for payment-related services, according to one example embodiment;

FIG. 5A is a flowchart of a process for data aggregation and efficient routing of the aggregated data for payment settlement, according to one embodiment;

FIG. 5B is a flowchart of a process for authenticating a user to access a payment-related service and synchronizing transaction information between integrated systems, according to one embodiment;

FIG. 5C is a flowchart of a process for determining preset rules for a registered user based on future expense information, according to one embodiment;

FIG. 5D is a flowchart of a process for determining credit ranking and credit score for registered users, according to one embodiment;

FIG. 5E is a flowchart of a process for transmitting payments for the aggregated outstanding amount based on historical transaction information, according to one embodiment;

FIG. 5F is a flowchart of a process for determining a reason for a failure of a payment transaction, according to one embodiment;

FIG. 5G is a flowchart of a process for determining a benefit program for registered users, according to one embodiment;

FIG. 6 is a time sequence diagram that illustrates a sequence of processes for intra-bank payment settlement, according to one embodiment;

FIG. 7 is an entity-relationship diagram that shows merchant entities within a processing engine of transaction processing system 109, according to one example embodiment;

FIG. 8 depicts an entity-relationship diagram between a merchant and customer within a processing engine of transaction processing system 109, according to one example embodiment;

FIG. 9 depicts a transaction entity-relationship within a processing engine of transaction processing system 109, according to one example embodiment;

FIG. 10 shows settlement entities within a processing engine of transaction processing system 109, according to one example embodiment;

FIG. 11 shows mapping between the entities discussed in FIGS. 7-10 within a processing engine of transaction processing system 109, according to one example embodiment;

FIG. 12 depicts a customer-centric entity relationship diagram, according to one example embodiment;

FIG. 13 represents a transaction-centric entity relationship diagram, according to one example embodiment;

FIG. 14 represents an entity relationship diagram on payment to a service provider, according to one example embodiment;

FIG. 15 represents a merchant-centric entity relationship diagram, according to one example embodiment;

FIG. 16 depicts an entity relationship diagram on payments to a merchant by the service provider, according to one example embodiment;

FIG. 17 is a flow diagram that shows a user registration process for payment-related services, according to one example embodiment;

FIG. 18 is a flow diagram that depicts a scenario wherein a registered user is using the payment-related services for travel purposes, according to one example embodiment;

FIG. 19 shows a payment flow for customer 101, according to one example embodiment;

FIG. 20 depicts an iterative flow for a payment-related service, according to one example embodiment;

FIG. 21 represents a payment flow for merchant 113, according to one example embodiment;

FIG. 22 depicts exception handling by transaction processing system 109, according to one example embodiment;

FIG. 23 is a swim lane flow diagram that provides a schematic overview of payment execution between a registered customer and a registered merchant, according to one example embodiment;

FIG. 24 is a flow diagram that represents customer enrollment for payment-related services, according to one example embodiment;

FIG. 25 represents a transaction flow for payment-related services, according to one example embodiment;

FIG. 26 represents a dashboard flow for payment-related services, according to one example embodiment;

FIG. 27 depicts a merchant settlement flow for payment-related services, according to one example embodiment;

FIG. 28 is a diagram that illustrates a payment transaction session for a registered user and merchants to the transaction, according to various example embodiments;

FIG. 29 shows an example machine learning training flow chart; and

FIG. 30 illustrates an implementation of a general computer system that may execute techniques presented herein.

### DETAILED DESCRIPTION OF EMBODIMENTS

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various embodiments of the present disclosure relate generally to smart forms and, more particularly, to a smart forms solution that enables large as well as mid-tier transactions (e.g., financial) institutions to provide configuration parameters in a streamlined manner so that developers can construct end-to-end solutions in an automated manner.

As described above, existing methods and systems for electronic payment transaction processing rely on complex communications among multiple entities in order to process a transaction without taking advantage of ubiquitous modern technology infrastructure. For example, in a traditional payment processing system, a consumer, during a checkout process with a merchant, pays for goods or services via payment vehicle at a POS terminal. Because merchants generally can use a different bank or financial institution than a consumer, an acquirer processor (not shown) handles the financial transactions between the financial institution of the consumer and that of the merchant. Merchant submitting payment transaction requests according to these traditional methods may encounter processing delays and higher fees from various intermediaries, e.g., acquirer processors, involved in the transaction. In the early days of payment transaction processing, such intermediaries were necessary because of the limited communication and data processing capabilities available to most merchants. However, modern communication and data processing capabilities make it possible for merchants to more readily connect to financial institutions directly. The embodiments of the present disclosure are directed to providing systems and methods for processing electronic payment transactions that take advantage of modern technology infrastructure.

Furthermore, at the time of purchase, a transaction is implemented in a process that involves authorization and capture of the payment amount. The payment amount of purchase transactions is recorded and settled at some point. Though merchants may desire to have the settlement occur as soon as possible, there are delays in the settlement of payments. Since payments are not final, and the dispute resolution process is expensive, merchants have no recourse. Thus, a merchant submitting payment transaction requests by the methods disclosed herein may achieve savings in reduced processing delays and/or avoided processing fees.

In addition, the pluralities of intermediaries involved in payment transactions may not have the same security or commitment to privacy as a bank, and may struggle to balance data availability, data confidentiality, and data integrity. So, there may be a risk for consumers' personal information to be hacked, misused, or intercepted. The consumers' submitting payment transaction requests by the methods disclosed herein may take advantage of a secure intra-bank or inter-bank payment method where the bank plays the role of both payer and payee, and carries out payment transactions on private networks to transfer funds.

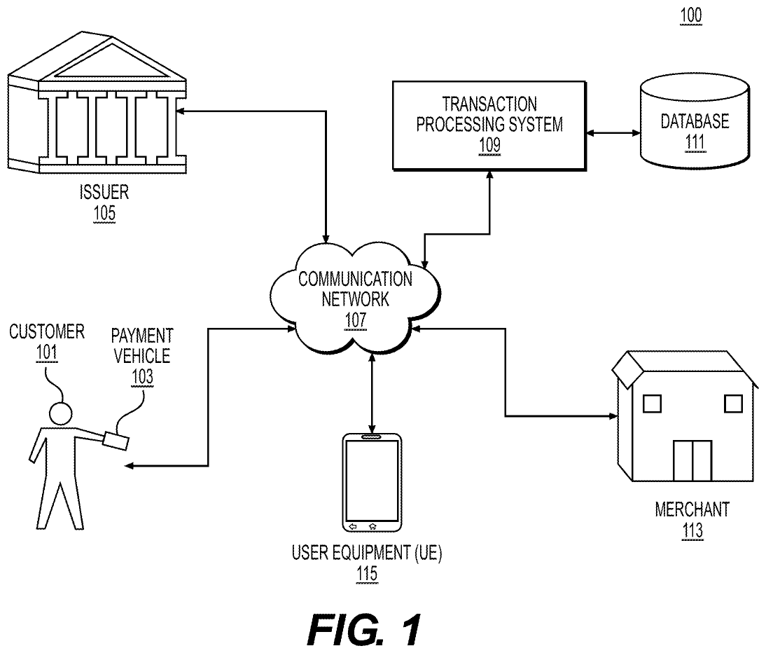

FIG. 1 is a diagram of a system capable of data aggregation and efficient routing of the aggregated data for settling payment between bank accounts associated with registered users, e.g., customer 101, and merchants, e.g., merchant 113, according to one example embodiment. FIG. 1 introduces a capability to implement modern communication and data processing capabilities into existing methods and systems for processing the payment transaction. FIG. 1, an example architecture of one or more example embodiments of the present invention, includes system 100 that comprises customer 101, payment vehicle 103, issuer 105, communication network 107, transaction processing system 109, database 111, and merchant 113.

In one embodiment, customer 101 may be an individual, a company, or other entity having accounts with issuer 105. Customer 101 may generally have at least one payment vehicle 103 associated with a payment account with issuer 105. In one embodiment, customer 101 is a registered user for payment-related services with transaction processing system 109.

In one embodiment, payment vehicle 103 may refer to any type of alternative to currency. As is to be clear to those skilled in the art, no aspect of the present disclosure is specifically limited to a specific type of payment vehicle. Therefore, it is intended that the following description encompasses the use of the present disclosure with many other forms of financial alternatives to currency, including debit cards, smart cards, single-use cards, prepaid cards, electronic currency (such as might be provided through a cellular telephone or personal digital assistant), credit cards, and the like. Payment vehicles can be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as debit, prepaid or stored-value cards, electronic benefit transfer cards, charge, credit, or any other like financial transaction instrument. In one embodiment, payment vehicle 103 may be used as a means of authentication, and no amount is levied to payment vehicle 103.

In one embodiment, issuer 105 is a bank that manages payment accounts on behalf of customer 101. For example, issuer 105 may hold accounts for customer 101, and customer 101 may have a payment vehicle 103 affiliated with that account. In another embodiment, issuer 105 is the bank that manages recipient accounts on behalf of merchant 113. For example, issuer 105 may hold accounts for merchant 113, and merchant 113 may receive payments for the goods and services rendered in that account.

Further, various elements of system 100 may communicate with each other through communication network 107. Communication network 107 may support a variety of different communication protocols and communication techniques. In one embodiment, communication network 107 allows transaction processing system 109 to communicate with customer 101, issuer 105, and merchant 113. The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular communication network and may employ various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one embodiment, transaction processing system 109 may be a platform with multiple interconnected components. Transaction processing system 109 may include one or more servers, intelligent networking devices, computing devices, components, and corresponding software for data aggregation and efficient routing of the aggregated data for payment settlement between bank accounts associated with a registered user and a merchant to a transaction. In addition, it is noted that transaction processing system 109 may be a separate entity of system 100. Further details of transaction processing system 109 are provided below.

In one embodiment, database 111 may be any type of database, such as relational, hierarchical, object-oriented, and/or the like, wherein data are organized in any suitable manner, including as data tables or lookup tables. In one embodiment, database 111 may store and manage multiple types of information that can provide means for aiding in the content provisioning and sharing process. In an embodiment, database 111 may include a machine-learning based training database with pre-defined mapping defining a relationship between various input parameters and output parameters based on various statistical methods. In an embodiment, the training database may include machine-learning algorithms to learn mappings between input parameters related to the user such as but not limited to financial transaction information, online activity information, historical user information and interests, contextual information, travel information, etc. In an embodiment, the training database may include a dataset that may include data collections that are not subject-specific, i.e., data collections based on population-wide observations, local, regional or super-regional observations, and the like. Exemplary datasets include retail data, market data, geographic data, encyclopedias, business information, financial information, and the like. In an embodiment, the training database is routinely updated and/or supplemented based on machine learning methods.

Merchant 113 may be a merchant offering goods and/or services for sale to customer 101. Merchant 113 may be equipped with a POS device (not shown), which is configured to receive payment information from payment vehicle 103 and to relay received payment information to transaction processing system 109. Merchant 113 can be any type of merchants, such as a brick-and-mortar retail location or an e-commerce/web-based merchant with a POS device or a web payment interface. In one embodiment, merchant 113 is registered with transaction processing system 109 for payment-related services.

In one embodiment, the user equipment (UE) 115 may include, but is not restricted to, any type of a mobile terminal, wireless terminal, fixed terminal, or portable terminal. Examples of the UE 115, may include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 115 may facilitate various input means for receiving and generating information, including, but not restricted to, a touch screen capability, a keyboard, and keypad data entry, a voice-based input mechanism, and the like. Any known and future implementations of the UE 115 may also be applicable.

By way of example, issuer 105, transaction processing system 109, merchant 113, and UE 115 communicate with each other and other components of the communication network 107 using well-known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

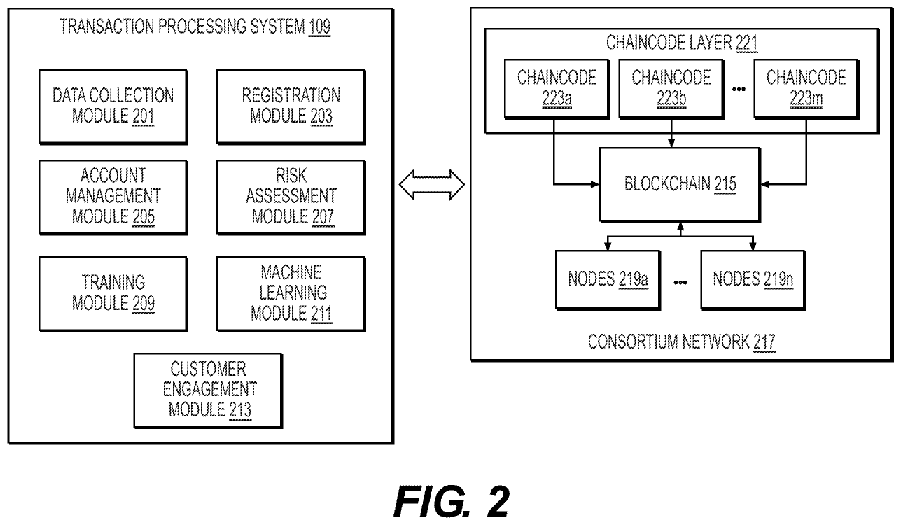

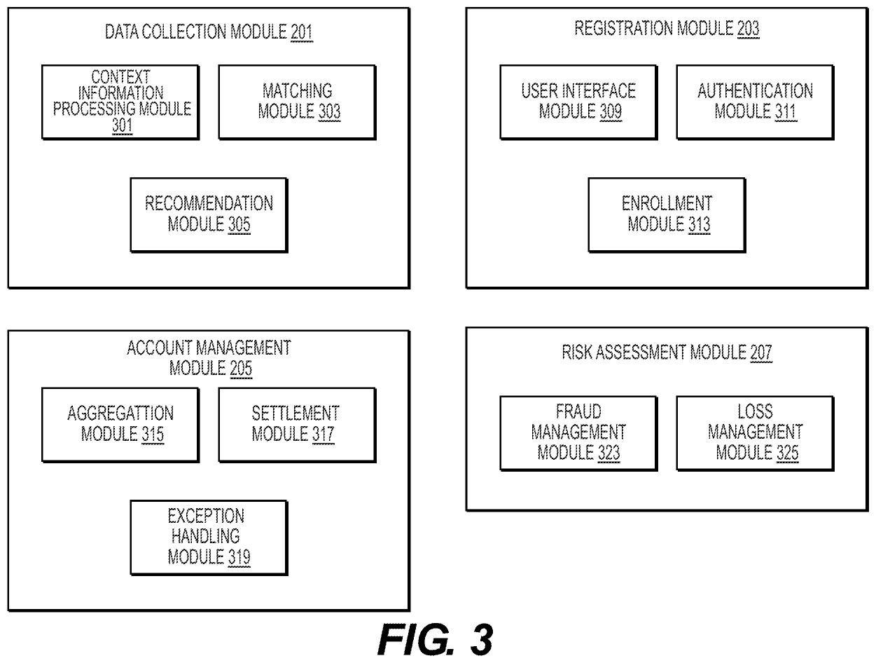

FIG. 2 is a diagram of the components of transaction processing system 109, and FIG. 3 is a diagram of the sub-components of the components in FIG. 2, according to one example embodiment. By way of example, the transaction processing system 109 includes one or more components for data aggregation and efficient routing of the aggregated data for the settlement of payments. It is contemplated that the functions of these components may be combined in one or more components or performed by other components of equivalent functionality. In one embodiment, transaction processing system 109 comprises data collection module 201, registration module 203, account management module 205, risk assessment module 207, training module 209, machine learning module 211, and customer engagement module 213, or any combination thereof.

In one embodiment, data collection module 201 may automatically collect relevant data associated with registered users or potential users through various data collection techniques. For example, the data collection module 201 may use a web-crawling component to access various databases or other information sources to determine the online activities information of the registered users or potential users. Data collection module 201 may be programmed to collect, in real-time, financial information pertaining to the registered users or potential users, so that the risk identification, analysis, response, monitoring, and control may be performed using the most recent data. In one example embodiment, data collection module 201 may include a software application, e.g., data mining applications in Extended Meta Language (XML), that automatically search for and return relevant information pertaining to the registered users or potential users. In one embodiment, data collection module 201 comprises context information processing module 301, matching module 303, and recommendation module 305.

In one embodiment, context information processing module 301 may determine context information associated with registered users, devices associated with the registered users, payment vehicles associated with the registered users, or a combination thereof. By way of example, the context information may include users' computing environment, users' data environment, online activities, historical information, preference information, spending patterns, or a combination thereof. Once received, context information processing module 301 may analyze the context information to trigger the execution of user interface module 309 in presenting relevant content to the registered users. In one example embodiment, context information processing module 301 may determine that a registered user regularly uses an online shopping portal to purchase goods and services, user interface module 309 may present an advertisement for a payment-related service on the online shopping portal to grab the user's attention.

In one embodiment, matching module 303 may retrieve a plurality of content from one or more devices, payment vehicles, or a combination thereof associated with the registered users. Matching module 303 may compare and evaluate the retrieved content with the corresponding data record to determine a degree of similarity. In one embodiment, matching module 303 may implement a text matching process or an image matching process, e.g., grid point matching, to compare and evaluate content for similarity. In one embodiment, matching module 303 may utilize one or more algorithms, e.g., machine learning algorithms, to determine a match for the content based, at least in part, on the comparison. Based on this matching, similar content is clustered in the same category for the registered users. In another embodiment, matching module 303 may match customer 101, e.g., consumer ID, with merchant 113, e.g., merchant ID, based on their unique identification number. In one example embodiment, a transaction involves customer 101 spending money for goods and services at one or more merchants 113, e.g., train travel expenses, filling car at a gas station, fast food meal, etc. Matching module 303 may co-relate customer 101 with each of the merchants to the transactions based on their unique identification number.

In one embodiment, recommendation module 305 may implement a deep learning-based recommendation system that aims to provide adaptive user representations which can process many forms of user interest/signal by assessing interests over the short-term vs. long-term. In another embodiment, recommendation module 305 may present a ranking of the registered users based, at least in part, on their financial history information and real-time financial information. In a further embodiment, recommendation module 305 may recommend potential users based on their financial history or may disapprove potential users based on their deficient financial history.

In one embodiment, registration module 203 comprises user interface module 309, authentication module 311, and enrollment module 313 to register one or more potential users. In one embodiment, user interface module 309 enables a presentation of a graphical user interface (GUI) in a device associated with a user (hereinafter “user devices”). User interface module 309 employs various application programming interfaces (APIs) or other function calls corresponding to the applications on the user devices, thus enabling the display of graphics primitives such as icons, menus, buttons, data entry fields, etc., for generating the user interface elements. In a further embodiment, user interface module 309 may cause interfacing of the guidance information with one or more users to include, at least in part, one or more annotations, audio messages, or a combination thereof. Still further, user interface module 309 may be configured to operate in connection with augmented reality (AR) processing techniques, wherein various applications, graphic elements, and features may interact. In one example embodiment, user interface module 309 may display a login widget in the user device, and the login widget may be linked to the payment facilitator computing system. User interface module 309 may ensure that the login widget is distinctive to be recognized by the users and unobtrusive to avoid any negative user experiences while visiting the linked websites. In a further example embodiment, user interface module 309 may comprise a variety of interfaces, for example, interfaces for data input and output devices, referred to as I/O devices, storage devices, and the like.

In one embodiment, authentication module 311 authenticates users and their devices for interaction with transaction processing system 109. It is noted that the authentication may include a first-time registration procedure for establishing one or more profile settings. In one embodiment, authentication may include receiving and validating a login name and/or user identification value as provided or established for a particular user during a registration process with the service provider. In one embodiment, the authentication procedure may also be performed through the automated association of database 111 with an IP address, a carrier detection signal of a user device, mobile directory number (MDN), subscriber identity module (SIM) (e.g., of a SIM card), radiofrequency identifier (RFID) tag or other identifiers. These means of authentication reduces privacy concern related to data sharing services.

Enrollment module 313 may enroll a user and/or a device associated with the user for payment-related service if the user desires enrollment. In one embodiment, enrollment module 313 may determine the eligibility of a user for enrollment based, at least in part, on information received from authentication module 311. In another embodiment, enrollment module 313 may comprise of a logic configured to determine the eligibility of a user for enrollment based, at least in part, on historical user information. In one instance, historical user information may include credit rating information, credit history information, adequate income, reasonable debt-to-income ratio, online fraud information, crime information, and the like. If the user and/or device associated with the user are eligible for enrollment, enrollment module 313 presents an enrollment offer in the user interface module 309. If the user responds positively to an enrollment offer, i.e., wants to be enrolled, enrollment module 313 may enroll the user and/or the device by updating a user profile associated with the user to reflect the enrollment of the user and/or device.

In one embodiment, account management module 205 may set up, modify, manage, and control a payment-related service account of a user. In one embodiment, account management module 205 comprises aggregation module 315, settlement module 317, and exception handling module 319.

In one embodiment, aggregation module 315 may collect or receive a set of transaction information, e.g., a log, a listing, a history, a file, a data structure, and/or other record types, associated with the registered users. Aggregation module 315 may classify the aggregated set of transaction information into various categories for efficient processing. In one embodiment, aggregation module 315 may collect or receive transaction information in real-time or per scheduled time interval.

In one embodiment, settlement module 317 may determine an optimal settlement path between the registered user and the merchants to a transaction. Settlement module 317 may implement a sophisticated rules engine that accesses account information, payee information, banking rules, and/or other information in performing transaction decisions. In one embodiment, settlement module 317 may process the categorized transaction information to determine whether the financial institution associated with the merchant is within the network of financial institutions of transaction processing system 109. Upon determining the merchant is within the network of financial institutions, e.g., merchant 113 holds an account at the same financial institution as customer 101, settlement module 317 initiates reconciliation of payments per the methods described herein.

In one embodiment, exception handling module 319 may detect transaction errors, e.g., failed transactions, rejected transactions, unfunded account rejections, etc., for registered users. In one example embodiment, exception handling module 319 may determine that the bank account of the registered user cannot be debited, e.g., insufficient amount. In one instance, exception handling module 319 may debit the bank account of the registered user during the next time interval or may levy a penalty based at least in part on information received from data collection module 201. In one example embodiment, exception handling module 319 may detect failed transactions for a registered user, and may alert the registered users on such failed transactions with recommendations on resolving the issue.

Risk assessment module 207 may perform the functions of risk identification, risk impacts, development of corresponding responses, and monitoring and control of risks. Risk assessment module 207 may execute one or more probability and/or statistical methods to determine a risk assessment value associated with a registered user. Risk assessment module 207 may periodically, per schedule, or in real-time monitor financial records of the registered users to determine a risk assessment value. For example, if a registered user or a potential user previously defaulted in their payments, e.g., refuse to pay the amount owed, or declared bankruptcy, risk assessment module 207 may predict higher risk in enrolling such users. In one example embodiment, risk assessment module 207 may assess payment data across different accounts, historical payment data across several accounts, to generate a financial risk score. In one embodiment, risk assessment module 207 comprises fraud management module 323 and loss management module 325.

In one embodiment, fraud management module 323 may monitor, in real-time, transactions of one or more registered users to detect anomalies during transactions, and may either block or flag the fraudulent transaction for review. Fraud management module 323 may maintain a whitelist and a blacklist of merchants based on the monitoring. In one example embodiment, fraud management module 323 may determine fraudulent transactions based on IP addresses or historical transaction information of the merchants to the transactions. In one embodiment, customer 101 may whitelist or blacklist merchant 113. In another example embodiment, fraud management module 323 may apply an address verification service (AVS) to compare the billing address supplied by a user to the address on file with the issuing bank. A mismatch in address information may be a sign of fraud. In a further example embodiment, fraud management module 323 may detect multiple failed purchase attempts in succession from a user and may block access to the user. In another embodiment, merchant 113 may whitelist or blacklist customer 101.

In one embodiment, loss management module 325 may monitor, detect, correct, or control sources of financial damage. Loss management module 325 may develop and implement policies and best practices that are designed to identify and minimize any risks that can lead to losses.

In one embodiment, training module 209 trains machine learning module 211 using various inputs to enable machine learning module 211 to automatically find contextual information associated with a registered user and/or a potential user from unstructured data. In another embodiment, training module 209 trains machine learning module 211 using various inputs to identify key data, e.g., descriptive data, supplemental data, etc., related to financial information of a registered user and/or a potential user. In a further embodiment, training module 209 trains machine learning module 211 using various inputs to enable machine learning module 211 to combine unstructured data with structured data to improve the accuracy of artificial intelligence models, validate data, and leverage for advisors and customer engagement. In one instance, the training module 209 can continuously provide and/or update machine learning module 211 during training using, for instance, supervised deep convolution network or equivalents.

In one embodiment, machine learning module 211 is data-driven and takes into account different combinations of the data. As can be appreciated by one skilled in the art, machine learning techniques can be used to predict and improve the potency of the user's data. Machine learning can ingest the user's data, draw parallels and conclusions across disparate data sets to provide refined data. The refined data can then be abstracted further by performing operations such as categorizing, coding, transforming, interpreting, summarizing, and calculating. Further, the abstracted data can be used in the future for decision-making. In one embodiment, machine learning module 211 may estimate the expense pattern of a registered user based, at least in part, on spending habits, shopping cart contents, etc. In another embodiment, the machine learning module 211 may also analyze historical records of the registered users to suggest different data points and outcomes to provide timely credit rating/scores. In an exemplary embodiment, data abstraction can be done by reviewing the user's payment transaction information and abstracting (i.e., extracting) key data, which can be used further. As a next step, analytics can then be performed on the abstracted data to determine payment-related services to improve the user's experience. In one embodiment, the analytics performed on the user's historical record can aid system 100 to determine the first preset time period, second preset time period, preset rules for payment-related services, benefit programs, etc. The data analytics can generate a dynamic report based on the refined user's record. Examples of the reports may include charts, graphs, pivot tables (e.g., the axis of which may be selectable by the users in real-time), dashboards, etc. Further, other available data analytics tools that depict the user's financial status can be used.

Customer engagement module 213 may implement a conversational user experience “UX” that presents one or more automated interfaces to the registered user via user interface module 309 and learns about the registered user based on information supplied by the registered user to the automated interface. Customer engagement module 213 may organize, automate, and synchronize user information to provide improved assistance and a personalized user experience. In one embodiment, customer engagement module 213 may include an artificial intelligence (AI) engine configured to use natural language processing to conduct automated conversations with the users. For example, customer engagement module 213 may automatically prompt the customer for one or more responses and automatically understand the intentions of the customer based on the response.

In one embodiment, system 100 implements artificial intelligence (AI), machine learning, and blockchain technology to locate the registered user's account and then automatically recommend them with payment-related service based on real-time processing of their historical information. The blockchain is configured to propagate one or more branching blockchains, wherein each branching blockchain is configured to propagate one or more additional branching blockchains. In general terms, blockchain 215 is an immutable cryptographically linked list of data blocks called a ledger and maintained within a distributed peer-to-peer framework such as a consortium network 217 with nodes 219a-219n (also collectively referred to as nodes 219). These nodes 219, for instance, each maintains an identical copy of the ledger by appending transactions that have been validated by a consensus protocol, grouped into blocks. Each block generally contains a cryptographic hash of previous block, a timestamp and transaction data (e.g., generally represented as a Merkle tree). The concept of blockchain 215 does not require a trusted authority or central server as all nodes 219 in the network 217 are equal and act as transaction initiators and validators at the same time, thereby providing full visibility of the blockchain 215 (e.g., the trust chain for consent transactions) across all nodes 219. All blocks that are added to blockchain 215 are unalterable and changing any of them retroactively would require alteration of all subsequent blocks which in turn requires consensus of network majority.

In a permissionless blockchain 215, virtually anyone can participate, and every participant is anonymous. In such a context, there can be no trust other than that the state of the blockchain 215, prior to a certain depth, is immutable. In order to mitigate this absence of trust, permissionless blockchains 215 typically employ a “mined” native cryptocurrency or transaction fees to provide economic incentive to offset the costs of participating in a form of byzantine fault tolerant (BFT) consensus based on “proof of work” (PoW) or “proof of stake” (PoS) algorithm.

Permissioned blockchains 215, on the other hand, operate a blockchain 215 amongst a set of known, identified and often vetted participants operating under a governance model that yields a certain degree of trust. Private and permission-based blockchains 215, for instance, are generally proposed for the business or enterprise sector. Permissioned blockchains 215 widely use an access control layer to govern who can access the distributed network 217. In one embodiment, new members are invited to join the consortium network 217 by a network owner (starter) or other members with the sufficient authorities applied by a set of rules or policies. By way of example, there are different types of access control mechanisms such as but not limited to: existing participants can invite newcomers; regulatory authority can issue a license or certificate for participation etc.

In one embodiment, the blockchain network (e.g., the consortium network 217) includes a smart contract or chaincode layer 221 comprising one or more smart contracts or chaincodes 223a-223m (also collectively referred to as chaincodes 223 or smart contracts 223). Each smart contract or chaincode 223 is automatically executable computer code running on top of a blockchain network (e.g., the consortium network 217), being encoded into blockchain 215 itself. It is noted that the terms “smart contract” and “chaincode” are used interchangeably even though chaincode is the Hyperledger Fabric implementation specific term for smart contract. Each smart contract or chaincode 223, for instance, contains a set of rules and conditions under which the parties of the “smart” contract agree to interact with each other. For example, a smart contract or chaincode 223 can initiate a recording of a request on the blockchain 215 after the nodes 219 verify that a payment has been made. In this way, the smart contract code or chaincode 223 facilitates, verifies, and enforces negotiation of agreements or transactions between parties.

For example, considering a blockchain 215 as the data, the smart contract or chaincode 223 is a logic which allows the manipulation of virtual assets. As described above, the chaincode 223 is executed (e.g., by nodes 219 of the consortium network 217 to reach a consensus) when programmed conditions are met. The advantage of the smart contract or chaincode 223 is that it does not require third-parties being involved in the agreement based on a blockchain 215. All transactions made are validated by required members or nodes 219 using the instantiations of the chaincode 223 and stored in the blockchain 215 only when consensus is met. In one embodiment, a smart contract or chaincode 223 is a secure and, in most cases, public way of managing assets, agreements, registries, etc. including but not limited to points to at least one registered user for the acquisition of a registered service.

The above presented modules and components of transaction processing system 109 may be implemented in hardware, firmware, software, or a combination thereof. Though depicted as a separate entity in FIG. 1, it is contemplated that transaction processing system 109 may be implemented for direct operation by respective UE 115. As such, transaction processing system 109 may generate direct signal inputs by way of the operating system of the UE 115. In another embodiment, one or more of the modules 201-213 may be implemented for operation by respective UEs, as transaction processing system 109, or a combination thereof. The various executions presented herein contemplate any and all arrangements and models.

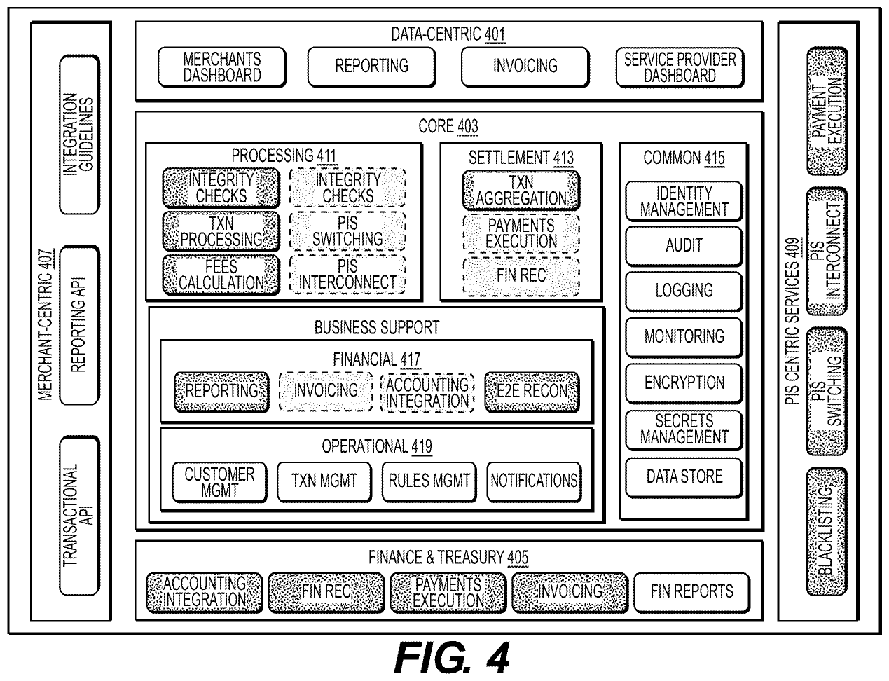

FIG. 4 is an architectural diagram for payment-related services, according to one example embodiment. By way of example, the architectural diagram comprises data-centric 401, core 403, finance and treasury 405, merchant-centric 407, and PIS-centric services 409, or any combination thereof. It is contemplated that the functions of these components may be combined in one or more components or performed by other components of equivalent functionality.

In one embodiment, data-centric 401 may include a merchant dashboard, reporting, invoicing, and service provider dashboard. In one example embodiment, data-centric 401 may generate a presentation of a plurality of data related to one or more transactions in a dashboard of UE 115 of a merchant and/or a service provider. For example, data-centric 401 may generate a simple GUI presenting information that is of interest to a merchant, e.g., transaction information, customer information, banking information, etc.

In one embodiment, core 403 may include processing 411, settlement 413, common 415, financial 417, and operational 419. In one embodiment, processing 411 may perform integrity checks on data related to one or more transactions to prevent and detect intentional or accidental data corruption. Such integrity checks ensure completeness and validity of the submitted data, e.g., whether the submitted values are consistent with the instructions and intent of the data submission guide. In another embodiment, processing 411 may also perform fees calculation, PIS switching, PIS interconnect, and/or transaction (TXN) processing.

In one embodiment, settlement 413 may aggregate payments for one or more transactions based, at least in part, on pre-determined rules. Thereafter, settlement 413 may initiate payments for the aggregated transaction amount. Settlement 413 may also store the aggregated transaction amount and the payments in database 111.

In one embodiment, common 415 may perform identity management, auditing, logging, monitoring, encryption, secrets management, and/or data storage of one or more transactions. In one example embodiment, common 415 may encrypt one or more transactions by generating a unique identifier hash recognizing the primary account numbers (e.g., PANs) or other identifiers of the transaction. In another example embodiment, common 415 may audit and monitor one or more transactions in real-time or per schedule.

In one embodiment, financial 417 may perform reporting, invoicing, account integration, and/or end-to-end (E2E) reconciliation. In one example embodiment, E2E reconciliation may involve analyzing and comparing transaction records from the point of origin. In one embodiment, the function of operational 419 may include accounting integration, recording, payment execution, invoicing, and reporting.

In one embodiment, merchant-centric 407 may include transactional API, reporting API, and integration guidelines. In one example embodiment, reporting API may provide a generic reporting mechanism to make reports available based on various platform features, e.g., content security policy or feature policy. The reporting API may enable the third party to pull precise results to answer specific questions and is usually powered by a query language or metric/dimension mapping.

In one embodiment, PIS-centric services 409 may perform the functions of blacklisting, PIS switching, PIS interconnect, and payment execution. In one example embodiment, PIS-centric services 409 may dynamically blacklist a customer and/or merchant when they exceed the authentication failure threshold or when a blacklisting rule is triggered as part of the authentication process.

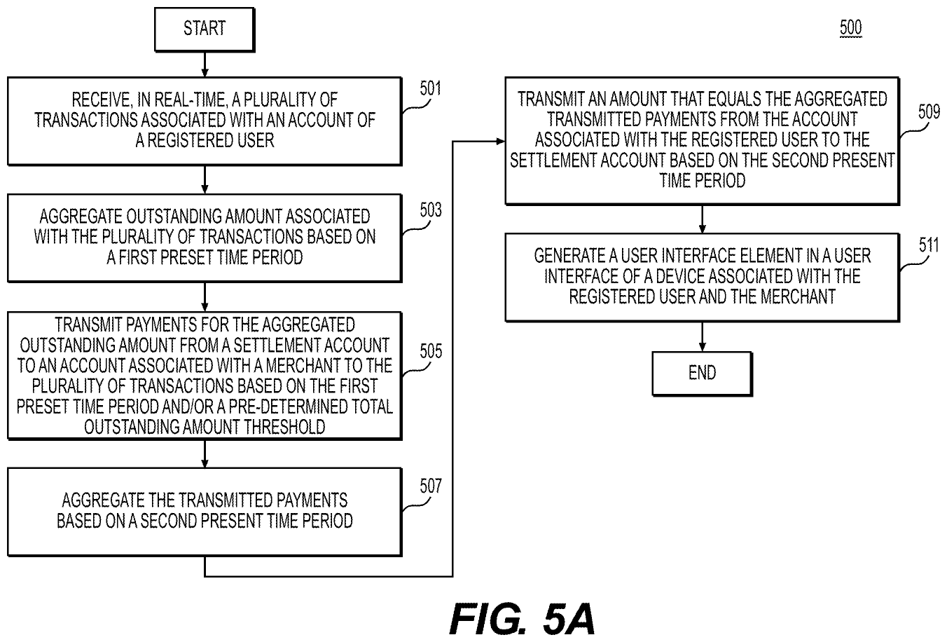

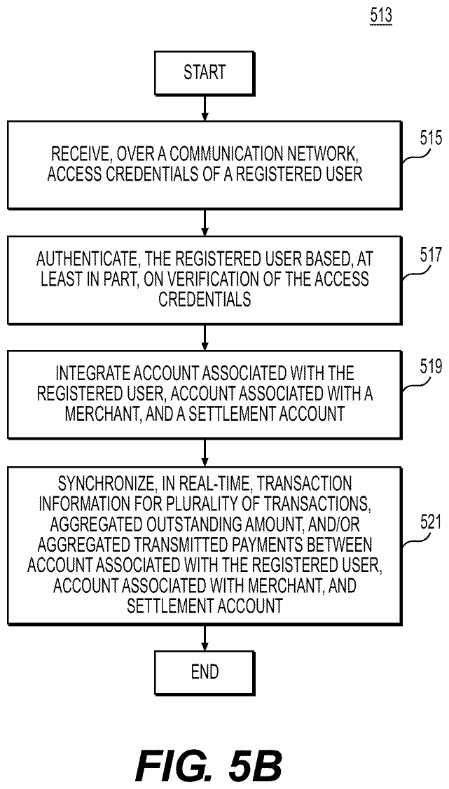

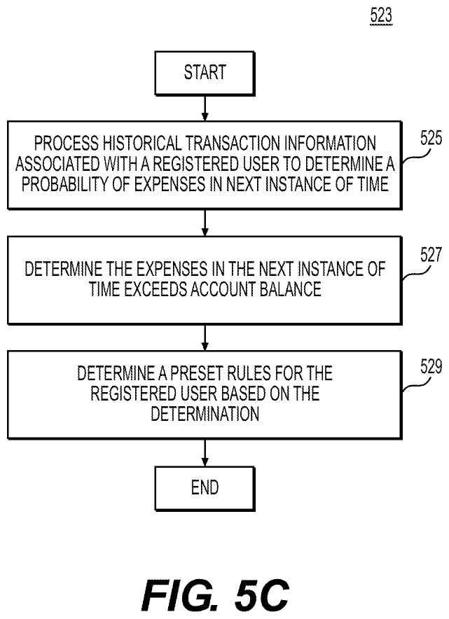

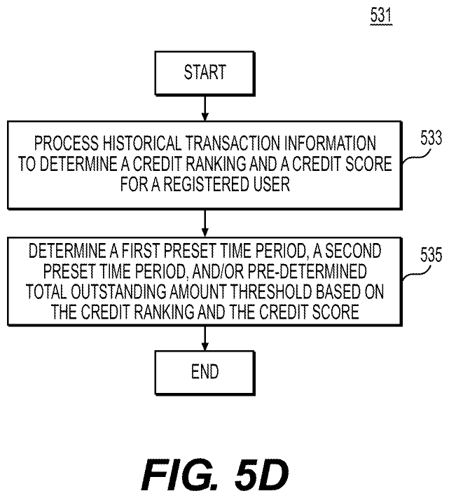

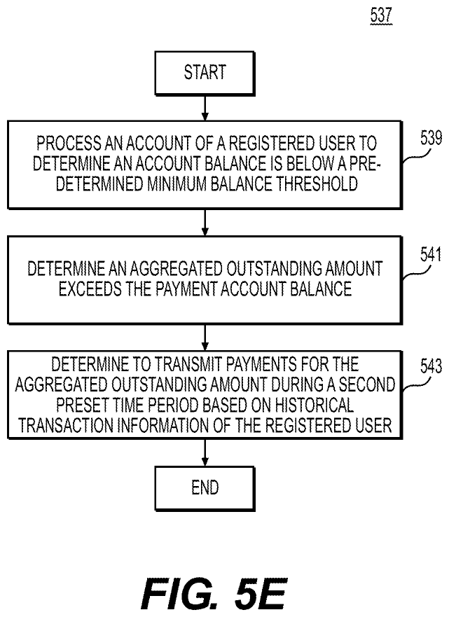

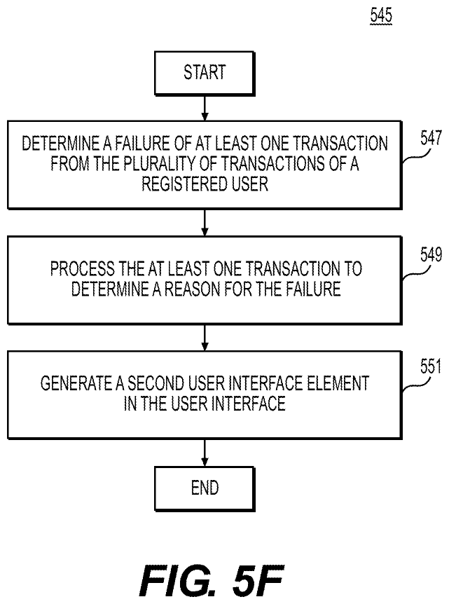

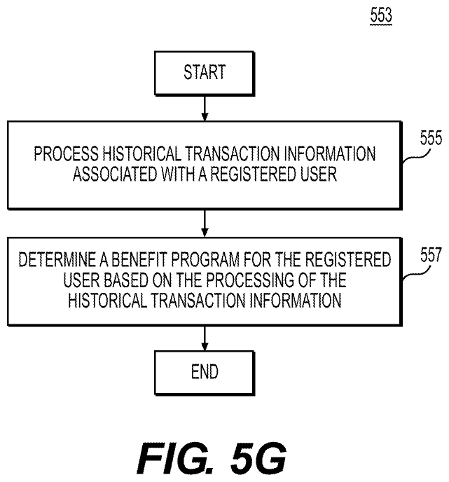

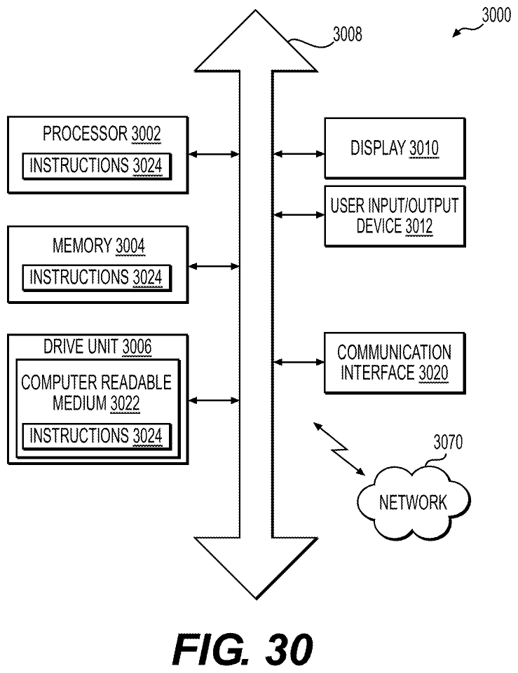

FIG. 5A is a flowchart of a process for data aggregation and efficient routing of the aggregated data for payment settlement, according to one embodiment. In various embodiments, transaction processing system 109 and/or any of modules 201-213 may perform one or more portions of process 500 and may be implemented in, for instance, a chip set including a processor and a memory as shown in FIG. 30. As such, transaction processing system 109 and/or any of modules 201-213 may provide means for accomplishing various parts of process 500, as well as means for accomplishing embodiments of other processes described herein in conjunction with other components of system 100. Although process 500 is illustrated and described as a sequence of steps, it is contemplated that various embodiments of process 500 may be performed in any order or combination and need not include all of the illustrated steps.

In step 501, transaction processing system 109 may receive, in real-time, a plurality of transactions associated with an account of a registered user. In one example embodiment, customer 101 may travel using the public bus multiple times a week, and when she taps her debit card on the magnetic card reader of the bus, her debit card is used as a means of identification and to authorize the commute. The actual cost of the commute is not debited from her payment account. In another example embodiment, customer 101 eats at a restaurant multiple times a week, and when she swipes her debit card on the POS terminal of the restaurant, the debit card is used as a means of authentication to authorize the meal. The actual cost of the meal is not debited from her payment account. Transaction processing system 109 receives and monitors, in real-time, the plurality of transactions associated with the payment account of customer 101.

In step 503, transaction processing system 109 may aggregate outstanding amount associated with the plurality of transactions based, at least in part, on a first preset time period. In one example embodiment, transaction processing system 109 may aggregate the expenses incurred in the payment account, e.g., the cost of the commutes and the meals, at the end of the day. In one embodiment, the first preset time period may be configured to an hourly basis, a daily basis, a weekly basis, per user preference, and so on. Such accumulation of expenses in a bundle reduces the processing cost incurred by merchant 113.

In step 505, transaction processing system 109 may transmit payments for the aggregated outstanding amount from a settlement account to an account associated with a merchant to the plurality of transactions based, at least in part, on the first preset time period, a pre-determined total outstanding amount threshold, or a combination thereof. In one embodiment, the payment account of customer 101 and the recipient account of merchant 113 are associated with the same financial institution. In one example embodiment, transaction processing system 109 may transmit payments to the recipient account for the aggregated expenses incurred in the payment account at the end of the day, e.g., the total cost for the commutes and the meals, from the settlement account. In another example embodiment, transaction processing system 109 may transmit payments from the settlement account to the recipient account upon determining that the expenses incurred in the payment account of customer 101 exceed the outstanding amount threshold limit. In one embodiment, the pre-determined total outstanding amount threshold may overrule the first preset time period or may work in conjunction with the first preset time period. This ensures faster and timely payments to merchant 113 for the goods and services rendered.

In step 507, transaction processing system 109 may aggregate the transmitted payments based, at least in part, on a second preset time period. In one embodiment, the first preset time period is a subset of the second preset time period. In one example embodiment, transaction processing system 109 may accumulate the payments transmitted to the recipient accounts of merchants 113 from the payment account of customer 101 during a three-day time period. For example, the payments were transmitted during the first preset time period, e.g., at the end of the day, and the transmitted payments were aggregated at the second preset time period, e.g., a three-day time period. In one embodiment, the second preset time period may be configured to a bi-weekly basis, a weekly basis, per user preference, and so on.

In step 509, transaction processing system 109 may transmit an amount that equals the aggregated transmitted payments from the account associated with the registered user to the settlement account based, at least in part, on the second preset time period. In one example embodiment, transaction processing system 109 debits the payment account of customer 101 for the payments transmitted to the recipient account of merchant 113 during the three-day time period. The debited amount is deposited into the settlement account. Such postponed deduction of payments for goods and services gives the consumer the choice to pay their debt over time.

In step 511, transaction processing system 109 may generate a user interface element in a user interface of a device associated with the registered user and/or the merchant. In one embodiment, the user interface element includes notification on the deduction of the aggregated transmitted payments from the payment account of customer 101. In another embodiment, the user interface element includes an alert on the aggregated outstanding amount during the first preset time period, and that the aggregated outstanding amount is debited from the payment account of customer 101 during the second preset time period. In a further embodiment, the user interface element includes notification on crediting the aggregated outstanding amount to the account associated with the merchant, e.g., the recipient account.

FIG. 5B is a flowchart of a process for authenticating a user to access a payment-related service and synchronizing transaction information between integrated systems, according to one embodiment. In various embodiments, transaction processing system 109 and/or any of modules 201-213 may perform one or more portions of process 513 and may be implemented in, for instance, a chip set including a processor and a memory as shown in FIG. 30. As such, transaction processing system 109 and/or any of modules 201-213 may provide means for accomplishing various parts of process 513, as well as means for accomplishing embodiments of other processes described herein in conjunction with other components of system 100. Although process 513 is illustrated and described as a sequence of steps, it is contemplated that various embodiments of process 513 may be performed in any order or combination and need not include all of the illustrated steps.

In step 515, transaction processing system 109 may receive, over a communication network, access credentials of the registered user. In one embodiment, the access credentials include predefined values, a preset username and password, international mobile equipment identity (IMEI), an electronic serial number, a mobile equipment identity (MEID), one or more identifiers unique to the device, or a combination thereof. In another embodiment, customer 101 may use other authentication mechanisms, e.g., log-in credentials of other social networking services, fingerprint log-in, or facial recognition log-in, to access the payment-related service.

In step 517, transaction processing system 109 may verify the access credentials of the registered user, e.g., customer 101, to authorize access to a payment-related service. In one example embodiment, customer 101 may enter access credentials in the log-in screen of UE 115, whereupon transaction processing system 109 may authenticate the credentials to grant access to the payment-related services or display an error notification, e.g., invalid log-in, to notify the user that the log-in credentials were incorrect. In one example embodiment, transaction processing system 109 may receive biometric information of the registered user, e.g., fingerprint, facial images, etc., and may verify the biometric information to authenticate the registered user to access the service. In another embodiment, transaction processing system 109 may notify the registered user to enter a ‘captcha’ to prevent automated software from creating fake accounts.

In step 519, transaction processing system 109 may integrate the account associated with the registered user, the account associated with the merchant, and the settlement account. In one embodiment, the integration is based on consent from the registered user and the merchants. In one example embodiment, the registered user and the merchants may authorize transaction processing system 109 to link the payment vehicle, the payment account, and the plurality of recipient accounts with the payment-related service during the registration process. Such integration/linkage of accounts with payment-related service of transaction processing system 109 facilitates the real-time transmission of payment information.

In step 521, transaction processing system 109 may synchronize, in real-time, transaction information for the plurality of transactions, the aggregated outstanding amount, the aggregated transmitted payments, or a combination thereof between the account associated with the registered user, the account associated with the merchant, and the settlement account. In one example embodiment, transaction processing system 109 may coordinate, in real-time, transaction information for the plurality of transactions in the payment account of customer 101, the aggregated outstanding amount in the payment account of customer 101, and the aggregated transmitted payments to the recipient account of merchant 113 with the payment-related service, e.g. settlement account.

FIG. 5C is a flowchart of a process for determining preset rules for a registered user based on future expense information, according to one embodiment. In various embodiments, transaction processing system 109 and/or any of modules 201-213 may perform one or more portions of process 523 and may be implemented in, for instance, a chip set including a processor and a memory as shown in FIG. 30. As such, transaction processing system 109 and/or any of modules 201-213 may provide means for accomplishing various parts of process 523, as well as means for accomplishing embodiments of other processes described herein in conjunction with other components of system 100. Although process 523 is illustrated and described as a sequence of steps, it is contemplated that various embodiments of process 523 may be performed in any order or combination and need not include all of the illustrated steps.

In step 525, transaction processing system 109 may process historical transaction information associated with the registered user to determine a probability of expenses in the next instance of time. In one embodiment, historical transaction information includes payments made by customer 101 for goods and services over a specified time period. In one example embodiment, transaction processing system 109 may determine that the daily expenses of customer 101 average around $150 based on the processing of historical transaction information.

In step 527, transaction processing system 109 may determine the expenses for the registered user in the next instance of time exceeds account balance. In one example embodiment, transaction processing system 109 may compare, in real-time, balance in the account of customer 101 with the expenses in the next instance of time, e.g., transaction processing system 109 may determine that the daily expenses of customer 101 average around $150. If the balance in the payment account is below the average expense of $150, then transaction processing system 109 determines that the payment account does not have sufficient balance to cover the anticipated expenses.

In step 529, transaction processing system 109 may determine one or more preset rules for the registered user based, at least in part, on the determination that the expenses in the next instance of time exceed the account balance. In one embodiment, preset rules include setting a limit to the payment for the anticipated expenses of customer 101 without an undue increase in the risk of defaults. In another embodiment, preset rules include generating an alert in the user interface of UE 115 associated with the registered user to add funds to the payment account or incur overdraft charges for the payment of the predicted aggregated outstanding amount. In a further embodiment, preset rules include deferring the payment for the predicted aggregated outstanding amount until the balance in the payment account matches the predicted aggregated outstanding amount.

FIG. 5D is a flowchart of a process for determining credit ranking and credit score for registered users, according to one embodiment. In various embodiments, transaction processing system 109 and/or any of modules 201-213 may perform one or more portions of process 531 and may be implemented in, for instance, a chip set including a processor and a memory as shown in FIG. 30. As such, transaction processing system 109 and/or any of modules 201-213 may provide means for accomplishing various parts of process 531, as well as means for accomplishing embodiments of other processes described herein in conjunction with other components of system 100. Although process 531 is illustrated and described as a sequence of steps, it is contemplated that various embodiments of process 531 may be performed in any order or combination and need not include all of the illustrated steps.

In step 533, transaction processing system 109 may process historical transaction information to determine a credit ranking and a credit score for the registered user. In one embodiment, the historical transaction information includes credit history information, income information, debt-to-income ratio information, or a combination thereof. In one example embodiment, higher income and/or lower debt-to-income ratio earn higher credit ranking and credit score for the registered user. Whereas, a lower income, higher debt-to-income ratio, and/or a record of defaulted payments garner lower credit ranking and credit score for the registered user.

In step 535, transaction processing system 109 may determine the first preset time period, the second preset time period, the pre-determined total outstanding amount threshold, or a combination thereof based on the credit ranking and the credit score. In one example embodiment, customer 101 with higher credit ranking and credit score may be provided with a higher pre-determined total outstanding amount threshold. In another example embodiment, customer 101 with higher credit ranking and credit score may be provided with a reduced first preset time period, and an extended second preset time period.

FIG. 5E is a flowchart of a process for transmitting payments for the aggregated outstanding amount based on historical transaction information, according to one embodiment. In various embodiments, transaction processing system 109 and/or any of modules 201-213 may perform one or more portions of process 537 and may be implemented in, for instance, a chip set including a processor and a memory as shown in FIG. 30. As such, transaction processing system 109 and/or any of modules 201-213 may provide means for accomplishing various parts of process 537, as well as means for accomplishing embodiments of other processes described herein in conjunction with other components of system 100. Although process 537 is illustrated and described as a sequence of steps, it is contemplated that various embodiments of process 537 may be performed in any order or combination and need not include all of the illustrated steps.

In step 539, transaction processing system 109 may process the account of the registered user to determine an account balance is below a pre-determined minimum balance threshold. In one example embodiment, transaction processing system 109 may set a minimum threshold limit for payment account balance at $250, and may alert the registered user, via UE 115, if the payment account balance is below $250. The minimum threshold limit may be based on the average expenses of the registered user. In one embodiment, the minimum threshold limit set by the transaction processing system 109 is separate from the minimum account balance set by the financial institution, e.g., issuer 105.

In step 541, transaction processing system 109 may determine the aggregated outstanding amount exceeds the payment account balance. In one example embodiment, transaction processing system 109 may compare the aggregated outstanding amount in the first preset time period with the balance in the user's account and may notify the user, via UE 115, if the account balance is lower than the aggregated outstanding amount.

In step 543, transaction processing system 109 may determine to transmit payments for the aggregated outstanding amount during the second preset time period based on the historical transaction information of the registered user. In one embodiment, the historical transaction information includes a predicted income of the registered user, wherein the predicted income is sufficient to settle the aggregated transmitted payments. In one example embodiment, transaction processing system 109 may determine that the payment account balance of the registered user is below the minimum threshold limit and the aggregated outstanding amount exceeds the payment account balance. The transaction processing system 109 may process the historical transaction information of the registered user to determine that the upcoming income of the registered user exceeds the aggregated outstanding amount. Transaction processing system 109 may determine to transmit payments for the aggregated outstanding amount.

FIG. 5F is a flowchart of a process for determining a reason for a failure of a payment transaction, according to one embodiment. In various embodiments, transaction processing system 109 and/or any of modules 201-213 may perform one or more portions of process 545 and may be implemented in, for instance, a chip set including a processor and a memory as shown in FIG. 30. As such, transaction processing system 109 and/or any of modules 201-213 may provide means for accomplishing various parts of process 545, as well as means for accomplishing embodiments of other processes described herein in conjunction with other components of system 100. Although process 545 is illustrated and described as a sequence of steps, it is contemplated that various embodiments of process 545 may be performed in any order or combination and need not include all of the illustrated steps.

In step 547, transaction processing system 109 may determine a failure of at least one transaction from the plurality of transactions of the registered user. In one example embodiment, transaction processing system 109 may process, in real-time, the plurality of payment transactions associated with the registered user to determine a payment for at least one transaction was unsuccessful.

In step 549, transaction processing system 109 may process at least one transaction to determine a reason for the failure. In one example embodiment, a payment transaction may fail because of insufficient funds in the customer's account, a technical glitch in the system, compromised card, communication error, the merchant to the transaction is blacklisted, the customer to the transaction is blacklisted or a combination thereof.

In step 551, transaction processing system 109 may generate a user interface element in the user interface of UE 115. In one embodiment, the user interface element is an audio and video alert on the reason for the failure of at least one payment transaction.

FIG. 5G is a flowchart of a process for determining a benefit program for registered users, according to one embodiment. In various embodiments, transaction processing system 109 and/or any of modules 201-213 may perform one or more portions of process 553 and may be implemented in, for instance, a chip set including a processor and a memory as shown in FIG. 30. As such, transaction processing system 109 and/or any of modules 201-213 may provide means for accomplishing various parts of process 553, as well as means for accomplishing embodiments of other processes described herein in conjunction with other components of system 100. Although process 553 is illustrated and described as a sequence of steps, it is contemplated that various embodiments of process 553 may be performed in any order or combination and need not include all of the illustrated steps.

In step 555, transaction processing system 109 may process historical transaction information associated with the registered user. In one embodiment, the historical transaction information includes past payment transactions, shopping basket contents, or a combination thereof.

In step 557, transaction processing system 109 may determine a benefit program for the registered user based, at least in part, on the processing. In one embodiment, the benefit program includes a loyalty program, a coupon redemption program, a lottery program, or a combination thereof. In one example embodiment, transaction processing system 109 may process the purchase history of the registered users to determine a benefits program suitable for the registered users. Transaction processing system 109 may then recommend a loyalty service, e.g., shopping rebates, coupons, rebates, and other benefits, to maintain the engagement level between the merchant brand and the consumer. In another example embodiment, transaction processing system 109 may create a shopping profile for customer 101 based on their spending behaviors. Thereafter, transaction processing system 109 may provide customer 101 with spend analysis and spend footprint, e.g., the amount spent by customer 101 on the types of goods and services. Customer 101 may then compare their profile with peers and/or monetize their profile against targeted offers. In a further example embodiment, transaction processing system 109 may provide a wallet expander service to customer 101, wherein a short term loan of a small amount, e.g., $50-$200, with low APR is provided to customer 101 short on funds at the end of the month. The loaned amount can only be spent on selected item categories, e.g., excluding tobacco, alcohol, cigarettes, etc. In another example embodiment, transaction processing system 109 may provide post-sales services, e.g., product repair and support services, product-related insurances, guaranty/warranty extensions, product recalls, etc.

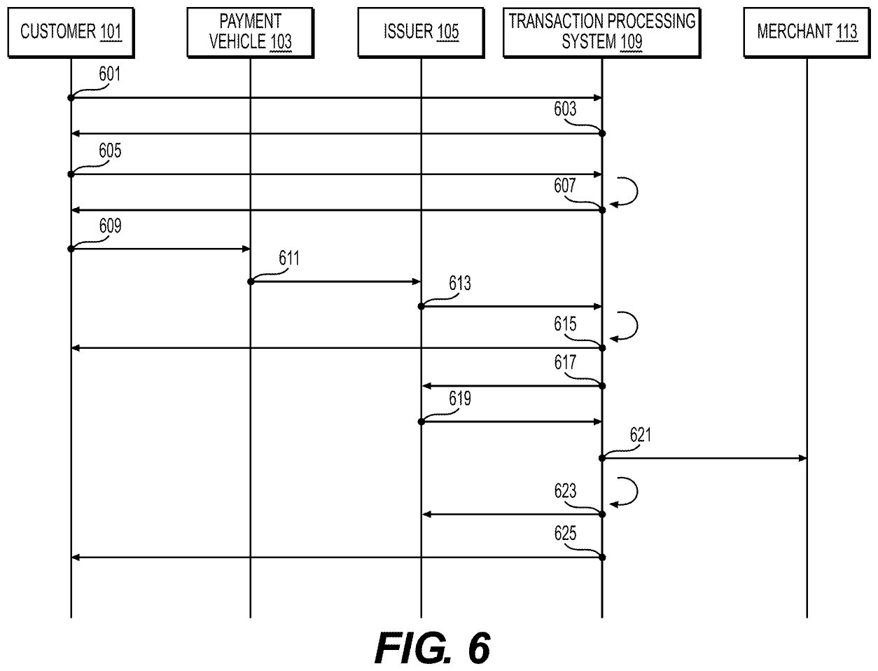

FIG. 6 is a time sequence diagram that illustrates a sequence of processes for intra-bank payment settlement, according to one embodiment. More specifically, FIG. 6 is a ladder diagram that illustrates a sequence of processes for intra-bank payment settlement using transaction processing system 109. A network process is represented by a thin vertical line. A step or message passed from one process to another is represented by horizontal arrows. Although illustrated and described as a sequence of steps, it is contemplated that various steps may be performed in any order or combination and need not include all of the illustrated steps.

In step 601, customer 101 may send a registration request to transaction processing system 109 for a payment-related service, and transaction processing system 109 may review and approve the registration request for customer 101 (step 603).

In step 605, customer 101 may input the log-in credentials to transaction processing system 109 to access the payment-related service. The log-in credentials may include predefined values, a preset username and password, international mobile equipment identity (IMEI), an electronic serial number, a mobile equipment identity (MEID), one or more identifiers unique to the device, biometric authentication, or a combination thereof. Transaction processing system 109 may grant access upon authenticating the log-in credentials or deny access upon determining the log-in credentials do not match or are incorrect (step 607). In one embodiment, transaction processing system 109 may tokenize log-in credentials to generate a token for authenticating and authorizing customer 101. A token may be a randomly generated number, a pseudorandom number, encrypted information, or other character sequences. Transaction processing system 109 may encrypt the token and may store the token in database 111. Such encryption of tokens may enhance data security as well as convenience in processing future transactions as they are unique per transaction or user.

In step 609, customer 101 may pay for goods or services via payment vehicle 103 at a POS terminal. Issuer 105 may then receive, in real-time, the transaction information in the payment account associated with customer 101 via POS terminal over communication network 107 (step 611). Issuer 105 transmits the transaction information, in real-time, to transaction processing system 109 (step 613). Upon receiving the transaction information, transaction processing system 109 may aggregate the outstanding amount in the payment account during a first preset time period, and transmit a notification regarding the aggregated outstanding amount to UE 115 associated with customer 101 (step 615). The notification may also include a message that the aggregated outstanding amount will be debited from the payment account during a second preset time period.

In step 617, transaction processing system 109 may transmit payments for the aggregated outstanding amount from a settlement account (not shown for illustrative convenience) to a recipient account associated with a merchant to the transaction. In one instance, the payment account of customer 101, the recipient account of merchant 113, and the settlement account may be associated with issuer 105, i.e., the same financial institution. In one embedment, transaction processing system 109 may transmit payments for the aggregated outstanding amount based on the first preset time period or pre-determined total outstanding amount threshold. Transaction processing system 109 may receive a payment confirmation from issuer 105 (step 619), whereupon transaction processing system 109 may present a notification pertaining to the deposit in the user interface of a device associated with the merchant (step 621).

Transaction processing system 109 aggregates the payments transmitted to the recipient account of the merchant during a second preset time period and then deducts the aggregated transmitted amount from the payment account of customer 101 (step 623). The deduction occurs during the second preset time period. The deducted amount is transmitted to the settlement account. In step 625, transaction processing system 109 generates a presentation in a user interface of a device associated with customer 101 regarding the deduction from the payment account.

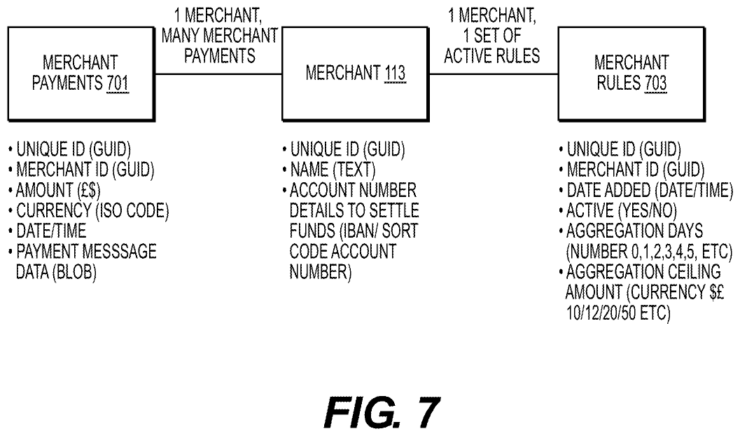

FIG. 7 is an entity-relationship diagram that shows merchant entities within a processing engine of transaction processing system 109, according to one example embodiment. In one embodiment, merchant 113 may have a one-to-many relationship with merchant payments 701, e.g., a merchant may receive a plurality of payments for the service rendered. In another embodiment, merchant 113 may have a one-to-one relationship with merchant rules 703, e.g., each merchant may have one set of active rules. In one embodiment, merchant payment 701, merchant 113, and merchant rules 703 may communicate, in real-time, during a payment transaction. In one example embodiment, merchant payment 701 may include unique ID (GUID), merchant ID (GUID), amount information, currency (ISO Code), temporal information, payment message data (blob), etc. In one example embodiment, merchant 113 may include unique ID (GUID), name information, account number details to settle funds (IBAN/sort code account number), etc. In one example embodiment, merchant rules 703 may include unique ID (GUID), merchant ID (GUID), temporal information, account status, aggregation days, aggregation ceiling amount, etc.

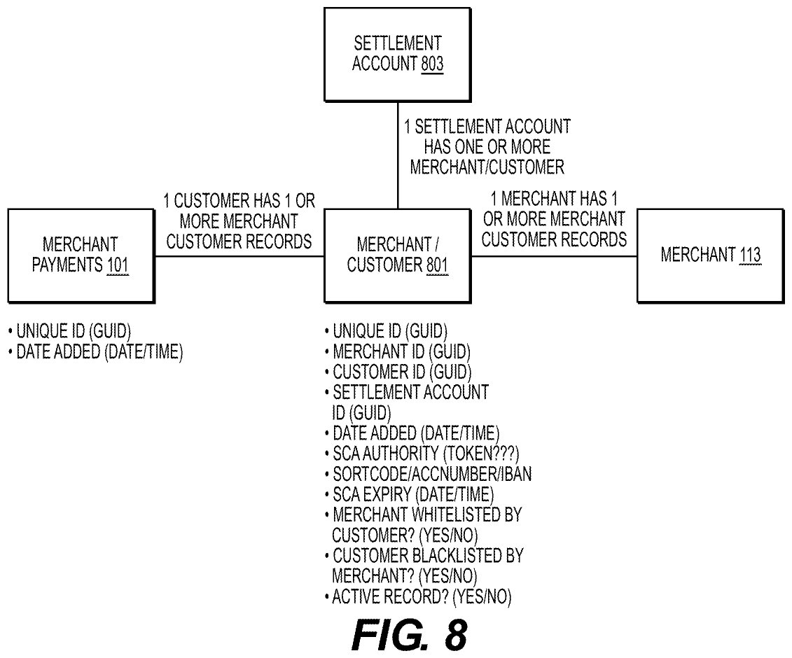

FIG. 8 depicts an entity-relationship diagram between a merchant and customer within a processing engine of transaction processing system 109, according to one example embodiment. In one embodiment, merchant/customer entity 801 may link customer 101, merchant 113, and settlement account 803. Merchant/customer entity 801 may store the payment information pertaining to customer 101 and merchant 113 relationships. In one embodiment, customer 101 may have a one-to-many relationship with merchant/customer entity 801, e.g., a customer may have 1 to N number of merchant/customer records. In one embodiment, merchant 113 may have a one-to-many relationship with merchant/customer entity 801, e.g., a merchant may have 1 to N number of merchant/customer records. In one embodiment, settlement account 803 may have a one-to-many relationship with merchant/customer entity 801, e.g., a settlement account may have 1 to N number of merchants/customers. In one example embodiment, merchant/customer entity 801 may include unique ID (GUID), merchant ID (GUID), customer ID (GUID), settlement Account ID (GUID), date added (date/time), SCA authority (token), sortcode/accnumber/IBAN, SCA expiry (date/time), merchant whitelisted by the customer, customer blacklisted by the merchant and/or transaction processing system 109, active record, etc. In one example embodiment, customer 101 may have a relationship with different merchants 113, and may want to utilize different bank accounts to pay merchants 113. Customer 101 may also want to change their payment details, hence transaction processing system 109 may maintain an “active record” to store historical information. In one example embodiment, customer 101 may get blacklisted by merchant 113 and/or transaction processing system 109 for payment default.

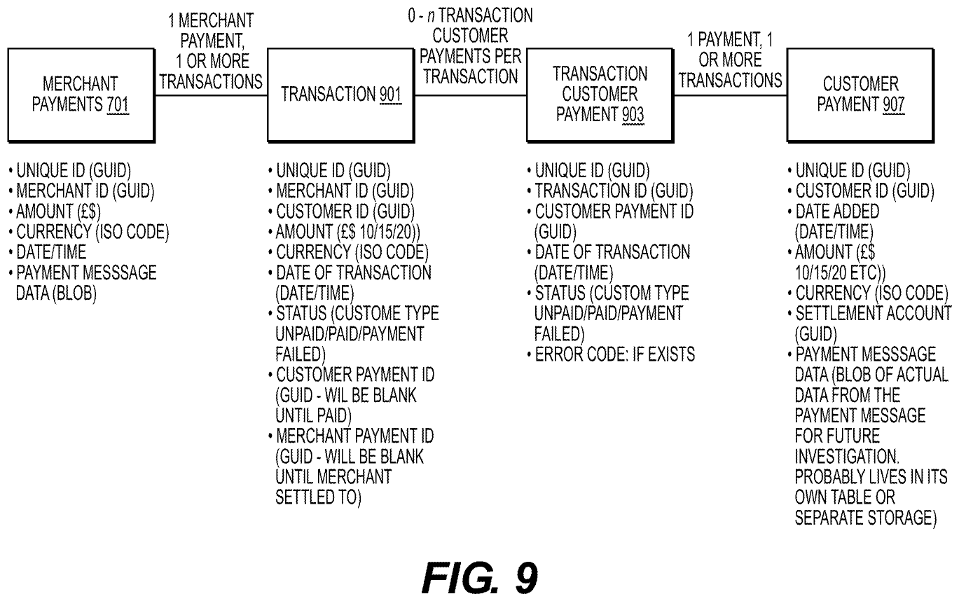

FIG. 9 depicts a transaction entity-relationship within a processing engine of transaction processing system 109, according to one example embodiment. In one embodiment, merchant payment 701 may have a one-to-many relationship with transaction 901, e.g., a merchant may receive a single total payment for one or more transactions. In one example embodiment, merchant payment 701 may include unique ID (GUID), merchant ID (GUID), amount information, currency information (ISO code), date of transaction (date/time), payment message data, etc. In one example embodiment, transaction 901 may include unique ID (GUID), merchant ID (GUID), customer ID (GUID), amount information, currency information (ISO code), date of transaction, status (custom type unpaid/paid/payment failed), customer payment ID (GUID—will be blank until paid), merchant Payment ID (GUID—will be blank until merchant's balance is settled). In one embodiment, transaction customer payment 903 may have a many-to-many relationship with transaction 901, e.g., a customer may either pay separately or may make a single payment for each of the 1 to N number of transactions. In one example embodiment, customer payment 905 may include unique ID (GUID), transaction ID (GUID), consumer payment ID (GUID), date of transaction (date/time), status information, error codes, etc. In one example embodiment, the status information may include: (i) transaction is ‘unpaid’ when received for the first time; (ii) transaction is ‘paid’ when requested payment has been received for a transaction, and (iii) transaction is ‘failed’ when payment for the request was unsuccessful. In one embodiment, customer payment 907 may have a many-to-many relationship with transaction customer payment 903. In one example embodiment, customer payment 907 may include unique ID (GUID), customer ID (GUID), date added (date/time), amount information, currency (ISO code), settlement Account (GUID), and payment message data, e.g., a blob of actual data from the payment message for future investigation, etc.

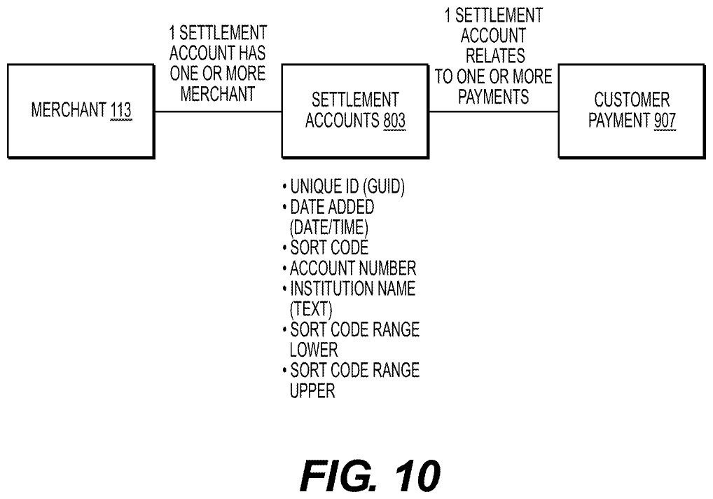

FIG. 10 shows settlement entities within a processing engine of transaction processing system 109, according to one example embodiment. In one embodiment, settlement account 803 may have a one-to-many relationship with merchant 113 and customer payment 907. In one embodiment, settlement accounts 803 may have records at different issuer 105. In one instance, these records may be used to identify the payment accounts of customer 101 and merchant 113, and to build a payment message by selecting a settlement destination account with the same issuer 105. This will be the same destination account the customer was presented with during registration. In one embodiment, settlement accounts 803 may include unique ID (GUID), date added (date/time), sort code, account number, institution name (text), sort code range lower, sort code range upper, etc.

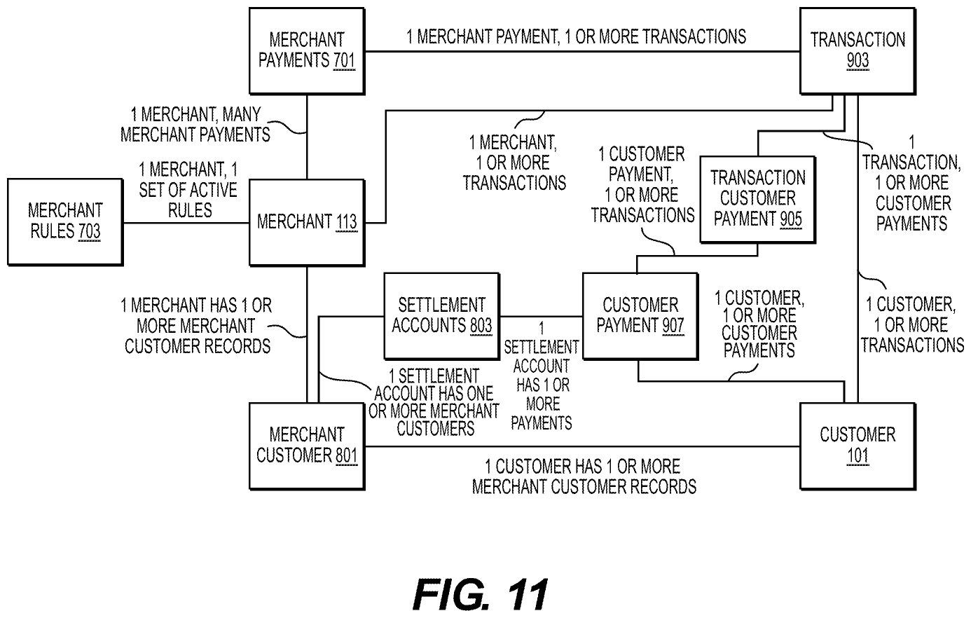

FIG. 11 is an entity-relationship diagram that shows an overall mapping between the entities discussed in FIGS. 7-10 within a processing engine of transaction processing system 109, according to one example embodiment.

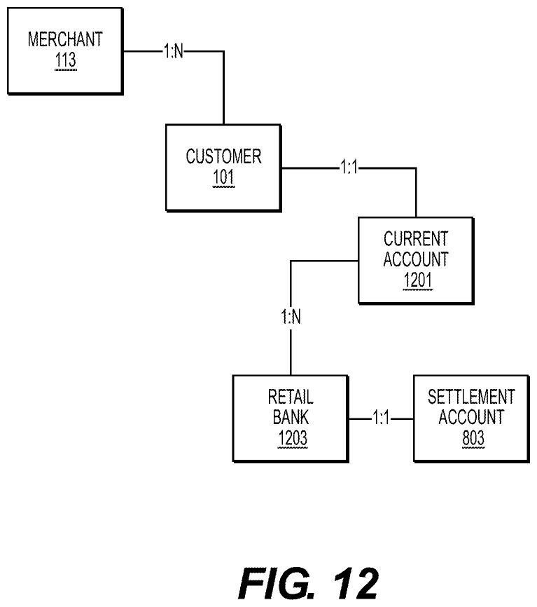

FIG. 12 depicts a customer-centric entity relationship diagram, according to one example embodiment. In this example embodiment, customer 101 has a one-to-one relationship with current account 1201 of retail bank 1203, e.g., a customer may maintain a single current account in a bank to pay a merchant for a plurality of transactions. On the other hand, merchant 113 may have a one-to-many relationship with customer 101, e.g., a merchant may engage in one or more transactions with a plurality of customers. Similarly, retail bank 1203, e.g., an issuer, may have one-to-many relationships with customer 101, e.g., a retail bank may have a plurality of current accounts for a plurality of customers. Retail bank 1203 may also have a one-to-one relationship with a settlement account 803, e.g., a retail bank may maintain a settlement account of the service provider to settle payments for a plurality of transactions between customer 101 and merchant 113.

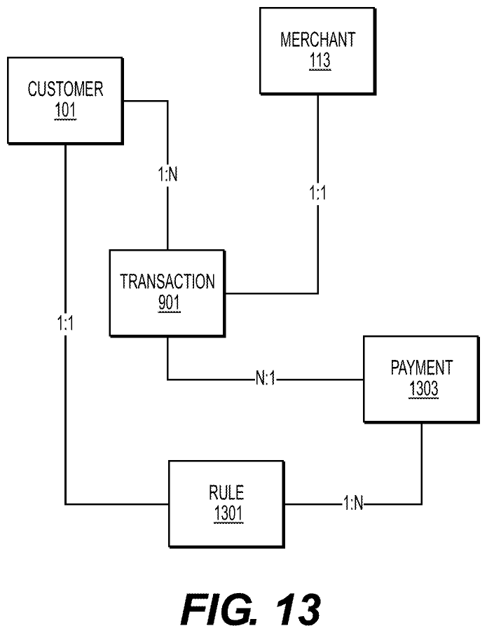

FIG. 13 represents a transaction-centric entity relationship diagram, according to one example embodiment. In this example embodiment, customer 101 may have a one-to-many relationship with transaction 901, e.g., a customer may have between 1 to N numbers of transactions with a merchant. Customer 101 may also have a one-to-one relationship with rules 1301, and rules 1301 may have a one-to-many relationship with payment 1303, e.g., a customer may have a set of active rules for the 1 to N numbers of transactions for payment to the merchant. On the other hand, payment 1303 may have a one-to-many relationship with transaction 901, e.g., a single payment for the 1 to N number of transactions with a single merchant. Transaction 901 may also have a one-to-one relationship with merchant 113.

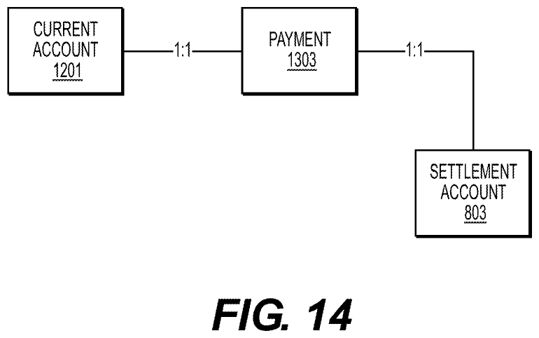

FIG. 14 represents an entity relationship diagram on payment to a service provider, according to one example embodiment. In this example embodiment, current account 1201 of customer 101 may have a one-to-one relationship with payment 1303, e.g., payments for each of the transactions come from the current account of the customer. Similarly, settlement account 803 may have a one-to-one relationship with payment 1303, e.g., the payment received from current account 1201 is transmitted to the settlement account of the service provider.

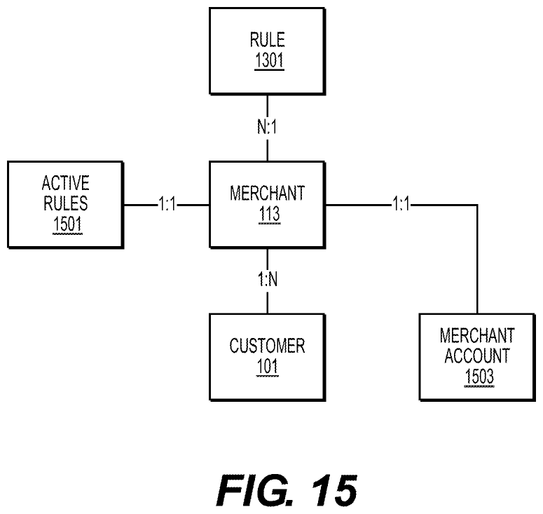

FIG. 15 represents a merchant-centric entity relationship diagram, according to one example embodiment. In this example embodiment, merchant 113 may have a one-to-many relationship with rules 1301, e.g., a merchant may have a plurality of rule sets. On the other hand, merchant 113 may have a one-to-one relationship with active rules 1501, e.g., a merchant has one set of active rules. Merchant 113 may also have a one-to-one relationship with merchant account 1503, e.g., a merchant has one merchant account to receive payments for the transactions or services rendered. On the other hand, merchant 113 may have a one-to-many relationship with customer 101, e.g., a merchant may do business with 1 to N number of customers.

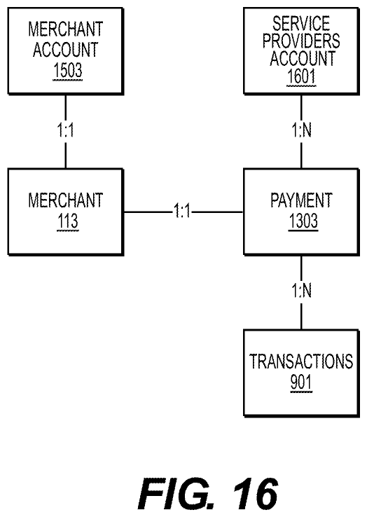

FIG. 16 depicts an entity relationship diagram on payments to a merchant by the service provider, according to one example embodiment. In this example embodiment, payment 1303 may have a one-to-one relationship with merchant 113, e.g., one payment relates to a plurality of transactions with one merchant. Merchant 113 may have a one-to-one relationship with merchant account 1503, e.g., a merchant may maintain a merchant account where the payments are deposited. Similarly, payment 1303 may have a one-to-one relationship with service provider's account 1601, e.g., one main settlement account of the service provider may settle payments for a plurality of transactions with one or more merchants. On the other hand, payment 1303 may have a one-to-many relationship with transactions 901, e.g., a payment may relate to 1 to N number of transactions.

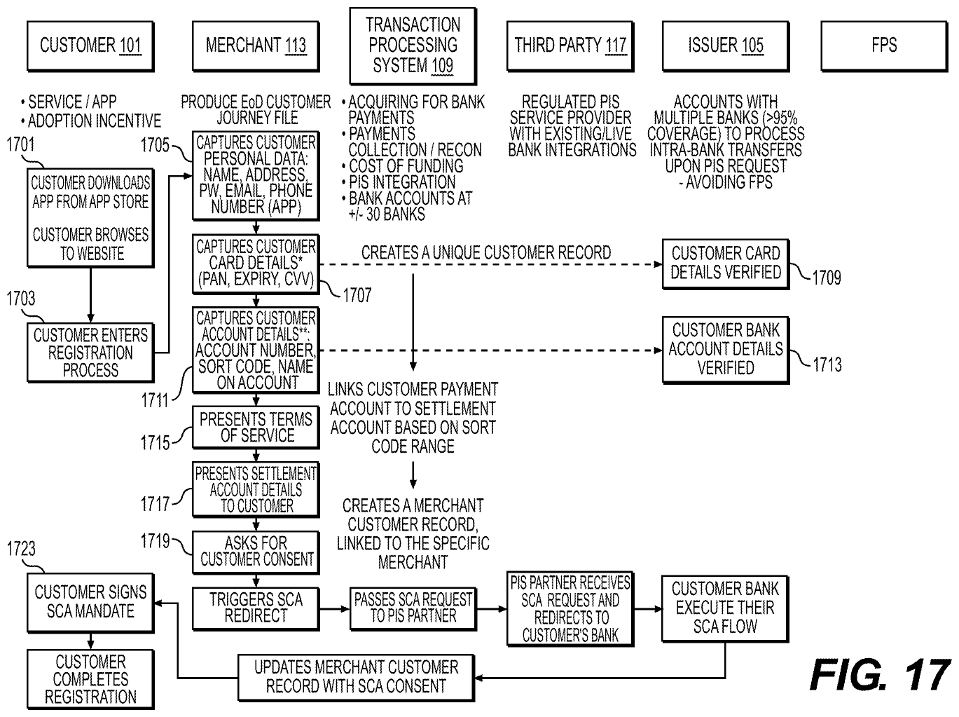

FIG. 17 is a flow diagram that shows a user registration process for payment-related services, according to one example embodiment. Although the registration process is illustrated and described as a sequence of steps, it is contemplated that these steps may be performed in any order or combination and need not include all of the illustrated steps.

In step 1701, customer 101 may download an application for the payment-related service in UE 115. In step 1703, customer 101 may enter the registration data, e.g., user credentials, personal data, card details, bank account details, etc. In step 1705, merchant 113 may capture the personal data of customer 101. In one embodiment, personal data includes personal information, address information, password, email, phone number, etc. In step 1707, merchant 113 may capture the card details of customer 101. In one embodiment, card detail includes card number, expiry date, CVV, etc.

In step 1709, transaction processing system 109 may verify the card details from issuer 105. In step 1711, merchant 113 may capture the account detail of customer 101. In one embodiment, account detail includes account number, routing number, sort code, etc. In step 1713, transaction processing system 109 may verify bank account from issuer 105. Merchant 113 may then generate a presentation of the terms of service in a user interface of UE 115 (step 1715). Upon acceptance of the terms of service by customer 101, merchant 113 may generate a presentation of the settlement account details in a user interface of UE 115 and then request for consent (steps 1717 and 1719). In one embodiment, a request for consent triggers redirection of SCA to PIS partners and the customer's bank. In step 1723, customer 101 may sign the SCA mandate to complete the registration. In one embodiment, merchant 113 may forward customer account details to transaction processing system 109 to create unique customer records, link the customer payment account to the settlement account based on sort code range, and create a merchant customer record linked to the specific merchant.

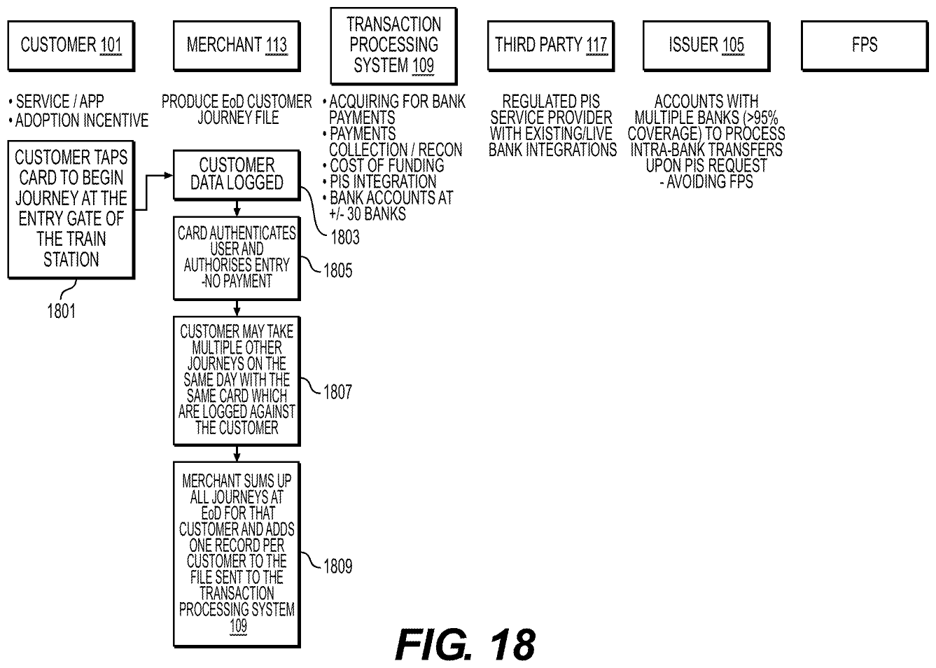

FIG. 18 is a flow diagram that depicts a scenario wherein a registered user is using the payment-related services for travel purposes, according to one example embodiment. Although the process for payment-related services is illustrated and described as a sequence of steps, it is contemplated that these steps may be performed in any order or combination and need not include all of the illustrated steps.

In step 1801, customer 101 is traveling via a train and taps his/her card at the entry gate of the train station. In step 1803, merchant 113 may, in real-time, record the customer data and may authorize customer 101 to use the train service based, at least in part, on the authentication of the card (step 1805). Customer 101 may take multiple trips, e.g., train trips, bus trips, car trips, bike trips, or any other type of transportation, during the day with the card (step 1807). In step 1809, merchant 113 may aggregate all trips of customer 101 at the end of the day and may add one record per customer to the file sent to the transaction processing system 109.

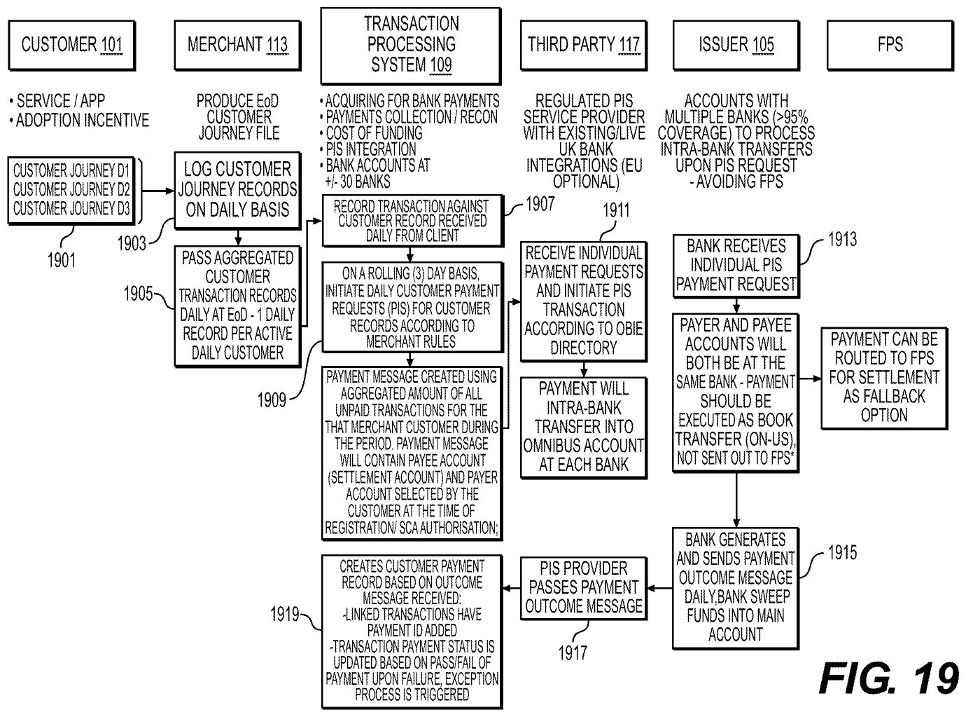

FIG. 19 shows a payment flow for customer 101, according to one example embodiment. Although the process for the payment flow is illustrated and described as a sequence of steps, it is contemplated that these steps may be performed in any order or combination and need not include all of the illustrated steps.

In step 1901, customer 101 may commute to work via public transport on a daily basis, this journey of customer 101 is logged by the service provider, e.g., merchant 113 (step 1903). In step 1905, merchant 113 may transmit the aggregated customer transaction records to transaction processing system 109 at the end of the day, e.g., one daily record per active daily customer. Transaction processing system 109 may record the transaction against the customer record received daily from the client (step 1907). In step 1909, transaction processing system 109 may on a rolling basis, e.g., every 3 days, initiate daily customer payment requests for customer records according to merchant rules. Payment message created using the aggregated amount of all unpaid transactions for the merchant customer during the period may contain payee account (settlement account) and payer account selected by the customer at the time of registration/SCA authorization.

In step 1911, third-party 117 may receive individual payment requests and may initiate PIS transactions according to the OBIE directory. The payment may be intra-bank transfer into an omnibus account at each bank. In step 1913, issuer 105 may receive individual PIS payment requests. In one embodiment, the payer and payee accounts may be at the same bank, and the payments may be executed as book transfers. In step 1915, issuer 105 may generate and transmit payment outcome messages, and the PIS provider passes the payment outcome message (step 1917). In step 1919, transaction processing system 109 may create customer payment records based on the outcome message received, e.g., linked transactions have payment ID added, transaction payment status is updated based on pass/fail of payment, and an exception process is triggered upon failure.

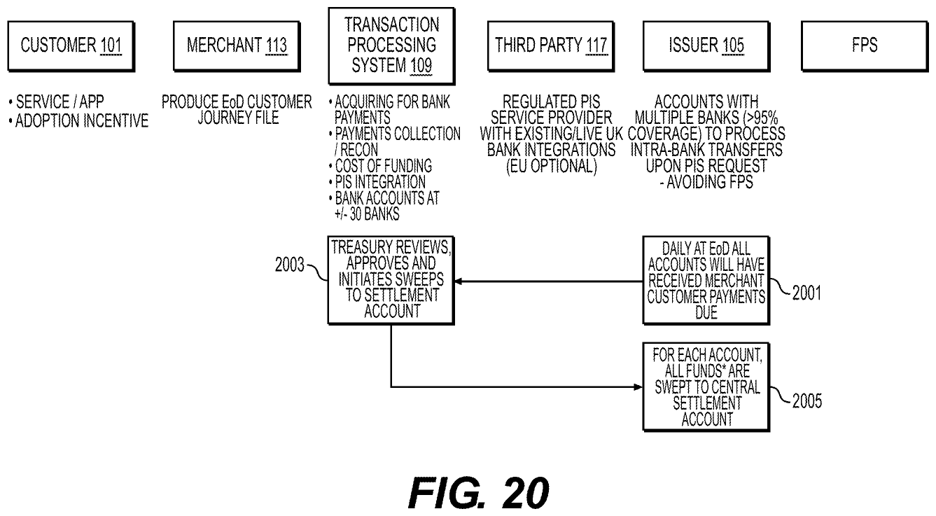

FIG. 20 depicts an iterative flow for a payment-related service, according to one example embodiment. Although the process is illustrated and described as a sequence of steps, it is contemplated that these steps may be performed in any order or combination and need not include all of the illustrated steps.

In step 2001, issuer 105 may receive, per schedule, merchant customer payments due at the end of the day, e.g., accumulated payments based upon predetermined time threshold. In step 2003, transaction processing system 109 may review and approve the accumulated payments to initiate sweeps to settlement accounts). In step 2005, for each account, all funds are swept to the central settlement account.

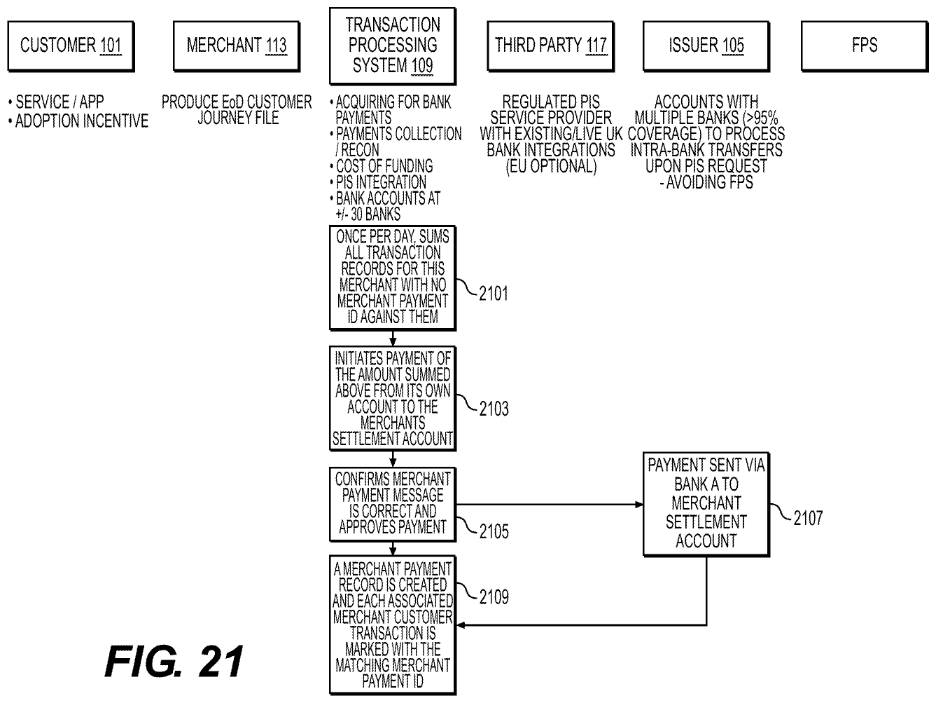

FIG. 21 represents a payment flow for merchant 113, according to one example embodiment. Although the process for the payment flow is illustrated and described as a sequence of steps, it is contemplated that these steps may be performed in any order or combination and need not include all of the illustrated steps.

In step 2101, transaction processing system 109 may sum all the transaction records for merchant 113. Transaction processing system 109 may initiate payment of the aggregated amount from its account to the settlement account of merchant 113 (step 2103). In step 2105, transaction processing system 109 may confirm that the merchant payment message is correct and approves the payment. The payment is sent to the settlement account of merchant 113 (step 2107). In step 2109, a merchant payment record is created and each associated merchant customer transaction is marked with the matching merchant payment ID.

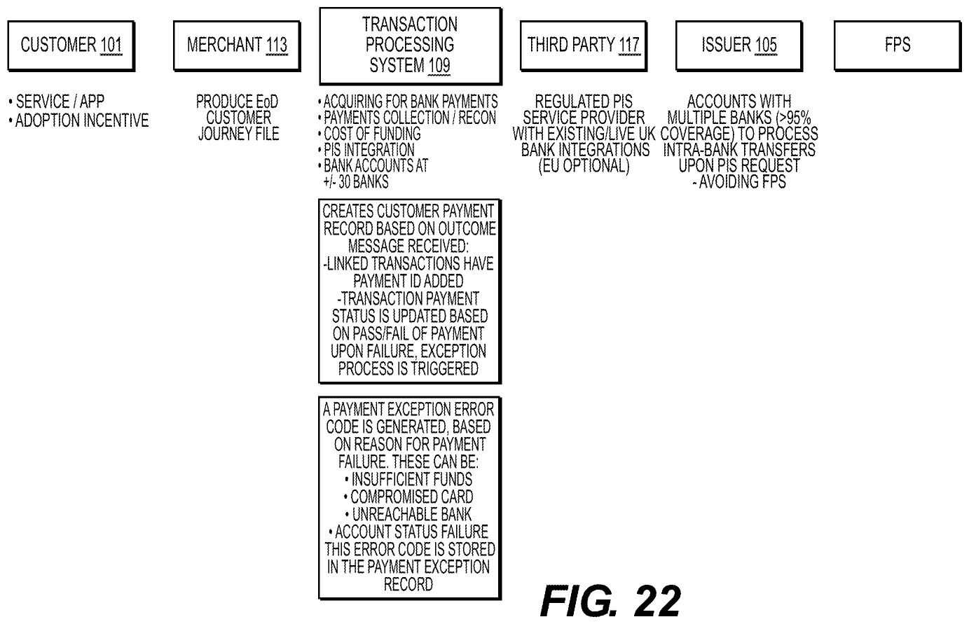

FIG. 22 depicts exception handling by transaction processing system 109, according to one example embodiment. In one embodiment, transaction processing system 109 may create customer payment records based on outcome message received, e.g., linked transactions have payment ID added, transaction payment status is updated based on pass/fail of payment. An exception is triggered upon the failure of the transaction. In one embodiment, transaction processing system 109 may generate a payment exception error code based on the reason for payment failure. These reasons may be insufficient funds, compromised card, unreachable bank, or account status failure. The error code is then stored in the payment exception record.

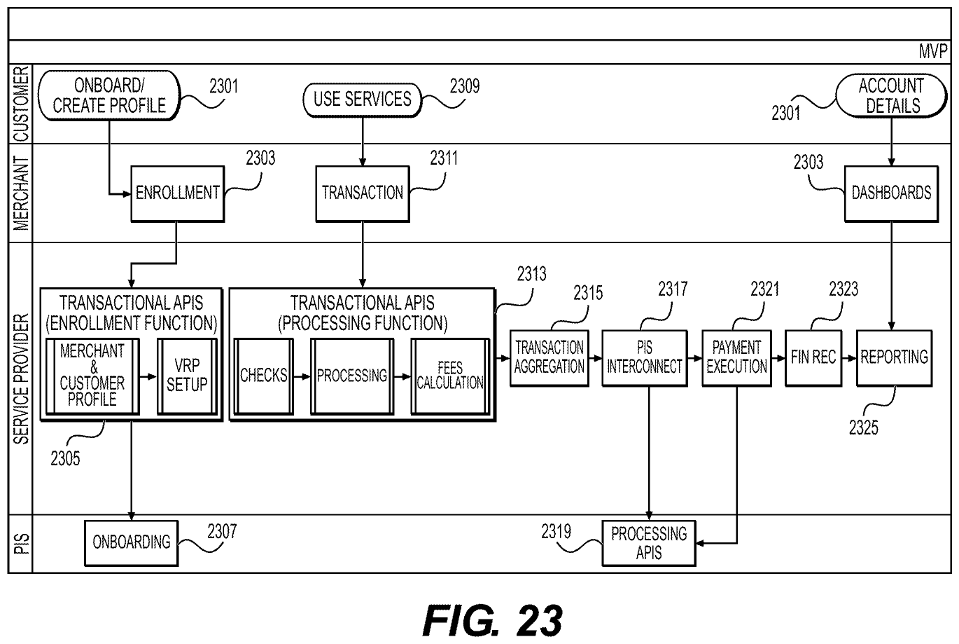

FIG. 23 is a swim lane flow diagram that provides a schematic overview of payment execution between a registered customer and a registered merchant, according to one example embodiment. Although the process is illustrated and described as a sequence of steps, it is contemplated that these steps may be performed in any order or combination and need not include all of the illustrated steps.

In one embodiment, the swim lane flow diagram depicts a customer onboarding process. In step 2301, a customer may initiate an onboarding process to receive a payment-related service by creating a profile via a user interface of UE 115. In one embodiment, the profile may include account information, user credentials, or other types of information associated with the customer. In step 2303, transaction processing system 109 may validate the credentials and may authorize the request for the payment transaction by enrolling the customer for a transaction-related service with a registered merchant. Such validation may occur in real-time or per schedule. In step 2305, transaction processing system 109 may process the merchant profile information and customer profile information to set up a variable recurring payment (VRP) function. In one embodiment, VRP is a form of payment instruction that may be set up and used to make a series of future payments. VRP may allow customers to safely connect an authorized third-party service provider to their bank account. In step 2307, transaction processing system 109 may initiate onboarding by presenting the application programming interface (API) of the authorized third-party service providers, e.g., payment initiation service (PIS). In one example embodiment, a PIS interface may ask the customer for consent and additional verification information, e.g., biometric information, and the customer may provide the consent and biometric information to complete the process. In one embodiment, all the bank details are sent through encrypted codes that use JSON arrays, both for data input and output.

In another embodiment, the swim lane flow diagram illustrates steps for payment execution for a plurality of transactions between the registered customer and the registered merchant. In step 2309, a customer utilizes a service offered by a merchant and may initiate a transaction with the merchant (step 2311). For example, the customer regularly commutes to work via a train service offered by the merchant. In step 2313, transaction processing system 109 may initiate processing of the transaction by: (i) performing routine checks of the transaction, (ii) processing the transaction per pre-defined rules, and (iii) performing fee calculation.

In step 2315, transaction processing system 109 may aggregate the amount for the plurality of transactions at a preset time period. In step 2317, transaction processing system 109 may transmit the aggregated amount to the authorized third-party service providers for processing. The authorized third-party service providers may process the aggregated amount (step 2319) and then initiate payment execution for the plurality of transactions (step 2321). The transmitted payments are recorded (step 2323) and then reported to the customer and the merchants (step 2325).

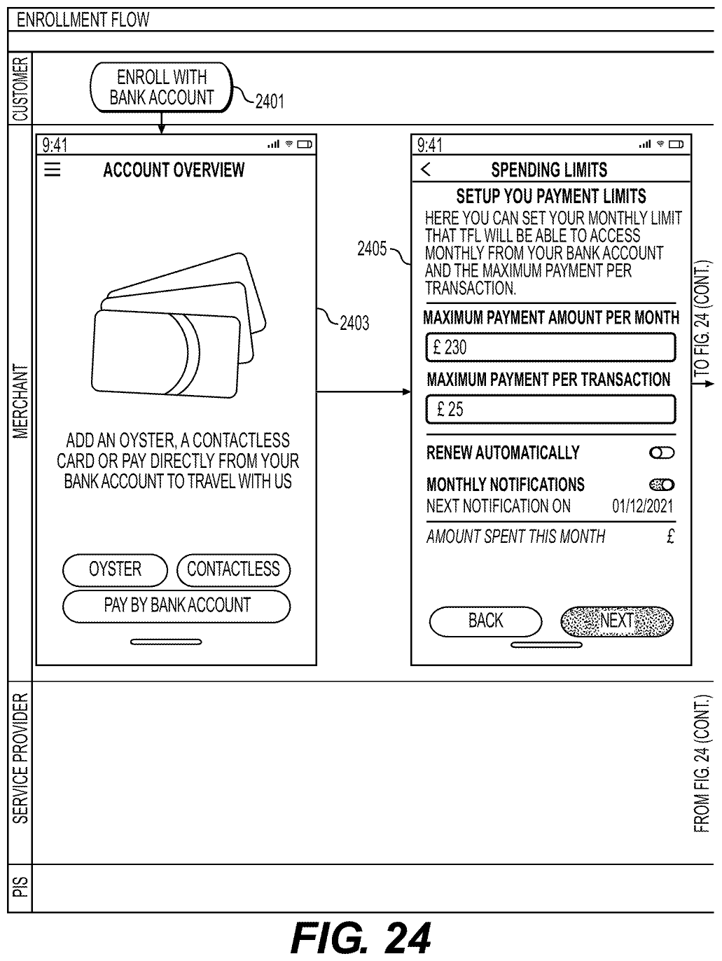

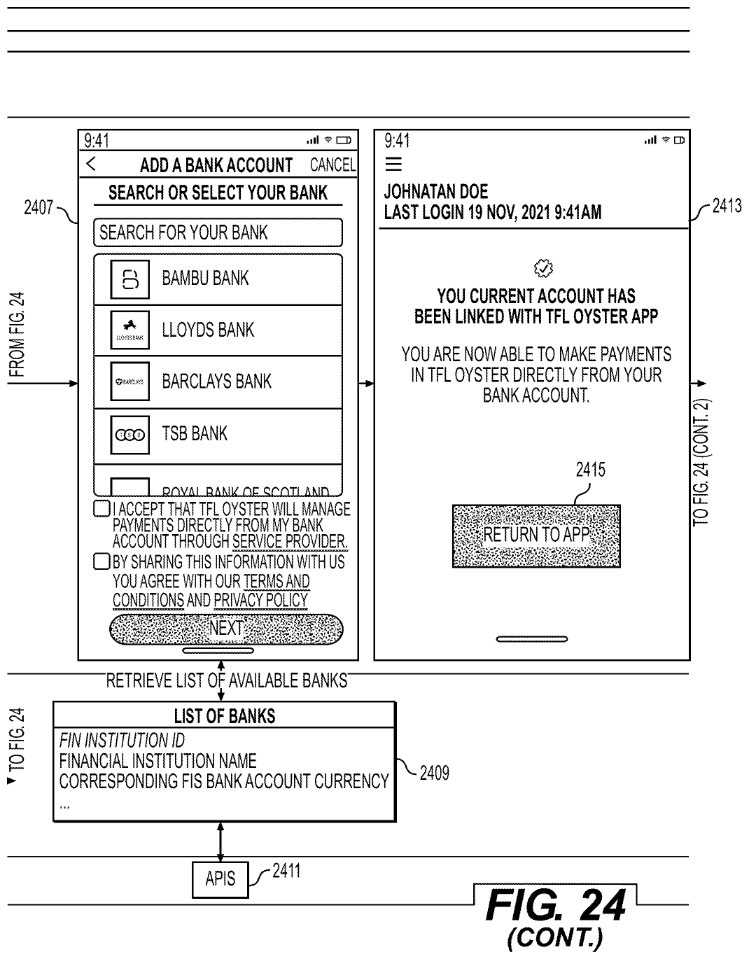

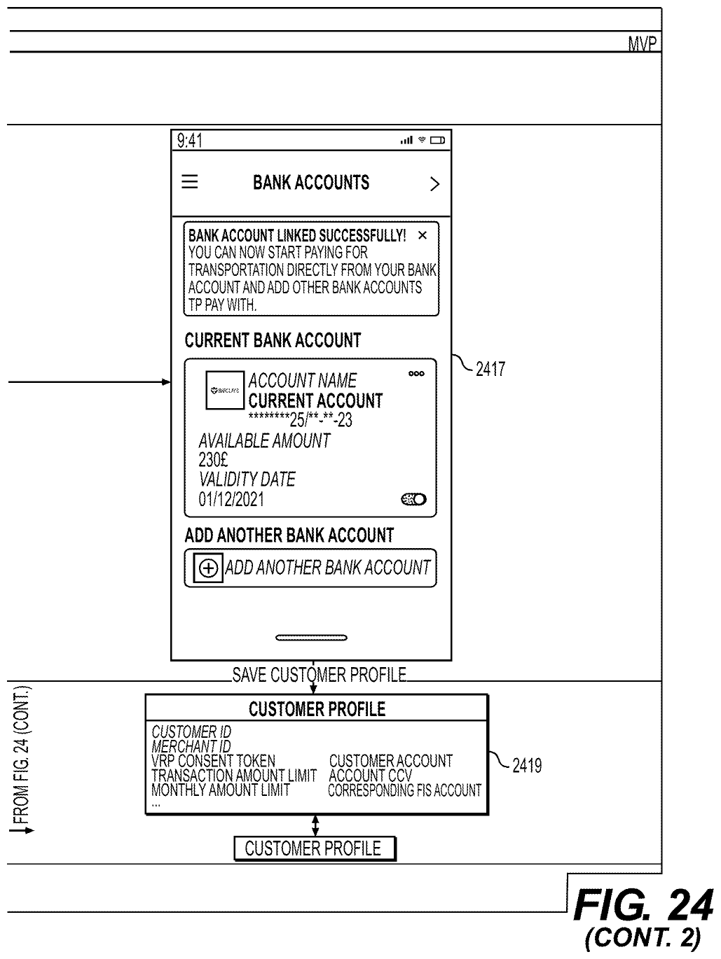

FIG. 24 is a flow diagram that represents customer enrollment for payment-related services, according to one example embodiment. Although the process is illustrated and described as a sequence of steps, it is contemplated that these steps may be performed in any order or combination and need not include all of the illustrated steps.

In step 2401, a customer may initiate the enrollment for a payment-related service by entering bank account information via a user interface of UE 115. Transaction processing system 109 may present user interface 2403 in UE 115 to notify the customer to enter the card information and/or bank account information. Once the customer provides the requested information, the customer is navigated to user interface 2405 for adjusting the payment threshold level. The customer may adjust the payment threshold level based on preference information and/or historical data. For example, a customer may set the maximum payment amount per month to £230 and/or a maximum payment per transaction to £25. The customer also has the option to renew the payment threshold level automatically or may choose to receive periodic notification for renewal of the payment threshold level. Transaction processing system 109 may also present user interface 2407 in UE 115 for the customer to search and select a bank of their choice. The customer may also accept the terms and conditions associated with the payment-related services.

Transaction processing system 109 may then retrieve the list of banks with banking information, e.g., financial institution ID, financial institution name, corresponding service provider's bank account, currency, etc., by interacting with the third-party service provider (2409) and the PIS API (2411). Once the enrollment process is complete, transaction processing system 109 may display user interface 2413 to notify the customer that the current account of the customer has been linked with the third-party service provider. The customer may click return to app tab 2415, whereupon the customer is directed to user interface 2417 for an account overview. User interface 2417 presents the bank account information, payment threshold level, and the validity date of the payment threshold level. The customer also has the option to add another bank account via user interface 2417. Transaction processing system 109 may save customer profiles in database 111 associated with the third-party service provider (2419). In one embodiment, the customer profiles may include customer ID, merchant ID, VRP consent token, transaction amount limit, monthly amount limit, customer account, account currency (CCY), corresponding service provider's account, etc.

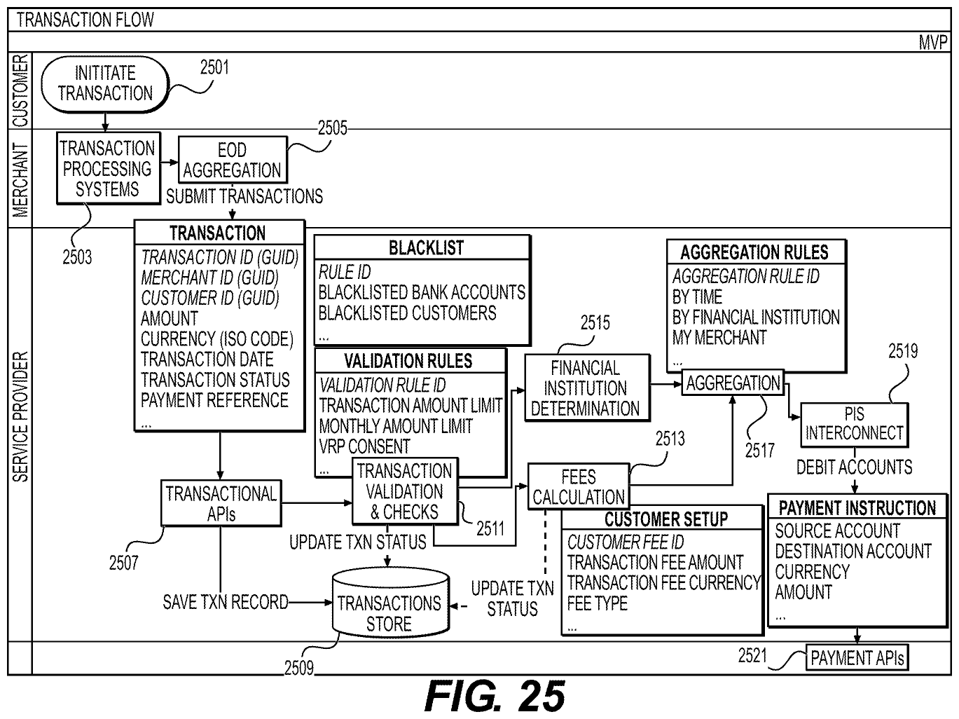

FIG. 25 represents a transaction flow for payment-related services, according to one example embodiment. Although the process is illustrated and described as a sequence of steps, it is contemplated that these steps may be performed in any order or combination and need not include all of the illustrated steps.

In step 2501, a customer may initiate a transaction with a merchant. Transaction processing system 109 may process the transaction (step 2503) and may aggregate the transactions per predetermined time period (step 2505).

In one embodiment, the aggregated transactions may include transaction ID, merchant ID, customer ID, amount, currency (ISO code), transaction date, transaction status, payment reference, etc. Transaction processing system 109 may transmit the aggregated transactions to the transactional API of the third-party service provider for further processing (step 2507). Transaction processing system 109 may save the received aggregated transactions in database 111 (step 2509). In step 2511, transaction processing system 109 may then perform checks and validation on the aggregated transactions. In one example embodiment, checks and validation may include rule ID, e.g., blacklisted bank accounts, blacklisted customers, etc., and validation rule ID, e.g., transaction amount limit, monthly amount limit, VRP consent, etc. Transaction processing system 109 may also perform fees calculation. In one example embodiment, fees calculation may include customer fee ID, e.g., transaction fee amount, transaction fee currency, fee type, etc. (step 2513).

In step 2515, transaction processing system 109 may determine the financial institution based, at least in part, on the transaction ID or banking information previously provided by the customer and the merchant. In step 2517, transaction processing system 109 may perform aggregation of the validated transaction and the calculated fees based on aggregation rules. In one example embodiment, aggregation rules may include aggregating the validated transaction and the calculated fees based, at least in part, on temporal information, financial institution, merchants, etc. Transaction processing system 109 may then forward the aggregated amount to the system of the third-party service provider (step 2519). Thereafter, transaction processing system 109 may send payment instructions to the payment API of PIS (step 2521). In one example embodiment, the payment instruction may include source account, destination account, currency, amount, etc.

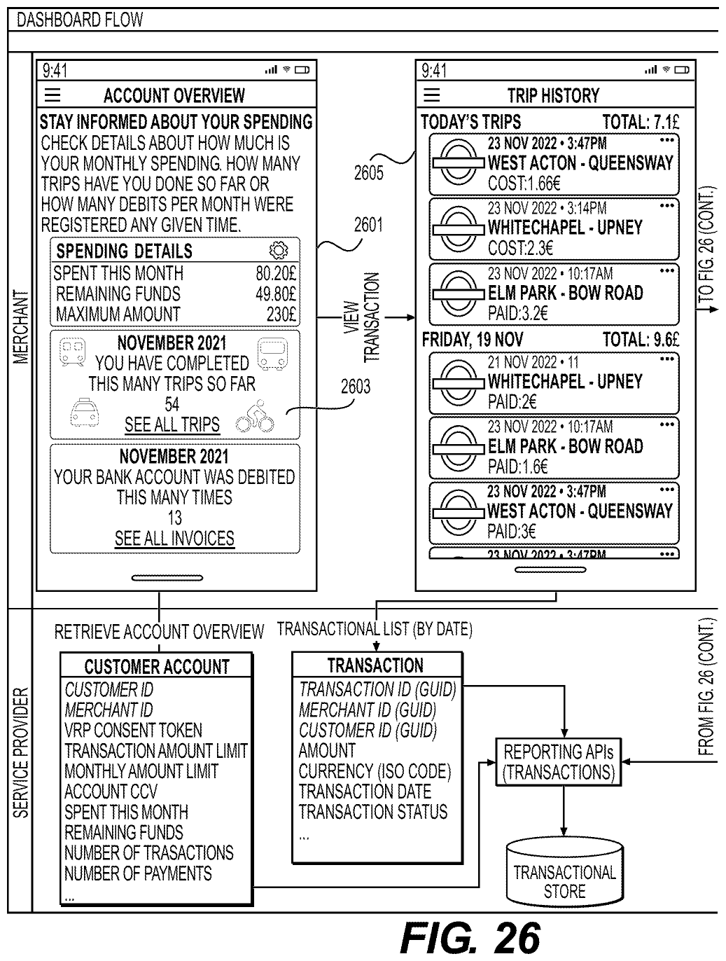

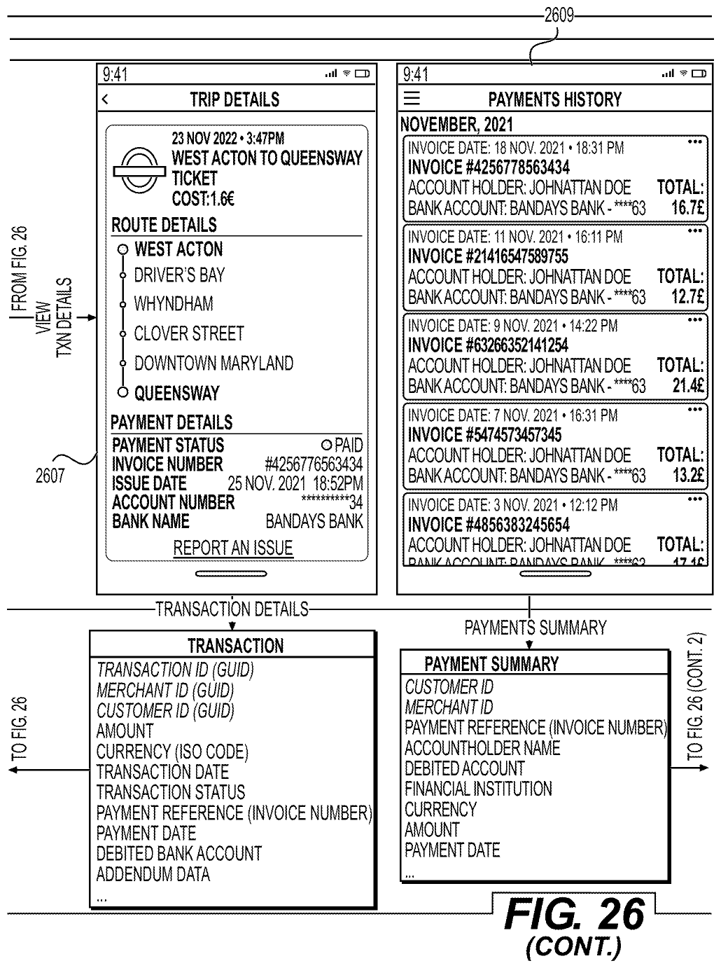

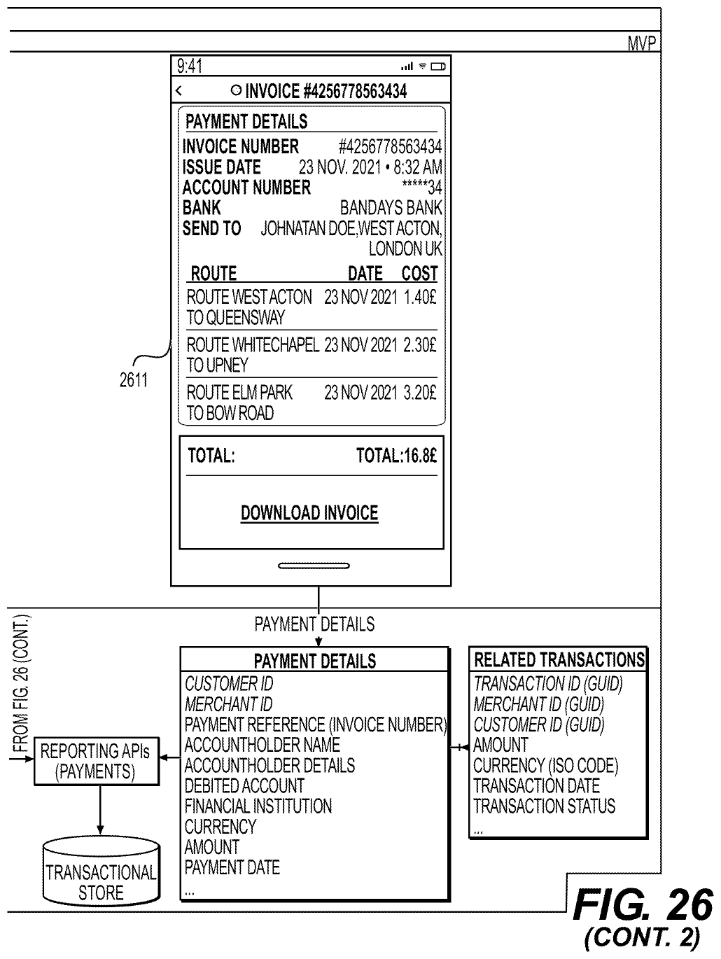

FIG. 26 represents a dashboard flow for payment-related services, according to one example embodiment. Although the process is illustrated and described as a sequence of steps, it is contemplated that these steps may be performed in any order or combination and need not include all of the illustrated steps.

User interface 2601 provides a customer with an overview of his/her account. Transaction processing system 109 may retrieve the account overview information from a transactional store, e.g., database 111. In one example embodiment, account overview information may include customer ID, Merchant ID, VRP consent token, transaction amount limit, monthly amount limit, account CCY, the amount spent this month, remaining funds, number of transactions, number of payments, etc. The customer may view the previously traveled trips by clicking ‘see all trips’ tab 2603, whereupon the customer is navigated to a new interface. User interface 2605 displays a list of previously traveled trips in chronological order. Each trip may display transaction information, e.g., transaction ID, merchant ID, customer ID, amount, currency (ISO code), transaction date, transaction status, etc. Transaction processing system 109 may then retrieve the transaction information from a transactional store, e.g., database 111.

The customer may select a trip from the list, whereupon the customer is directed to user interface 2607 with additional transaction details. The additional details may include transaction ID, merchant ID, customer ID, amount, currency (ISO code), transaction date, transaction status, payment reference (invoice number), payment date, debited bank account, addendum data, etc. The customer may also access user interface 2609 for payment history. In one example embodiment, payment history may include customer ID, merchant ID, payment reference (invoice number), account holder name, debited account, financial institution, currency, amount, payment date, etc. The customer may select an invoiced item from the user interface 2609 to view additional payment detail. User interface 2611 provides the additional payment detail for the selected item. In one example embodiment, the additional payment information may include transaction ID, customer ID, merchant ID, payment reference (invoice number), accountholder name, account holder details, debited account, financial institution, currency, amount, payment date, related transaction information, etc. Transaction processing system 109 may retrieve the payment history and additional payment detail from a transactional store, e.g., database 111.

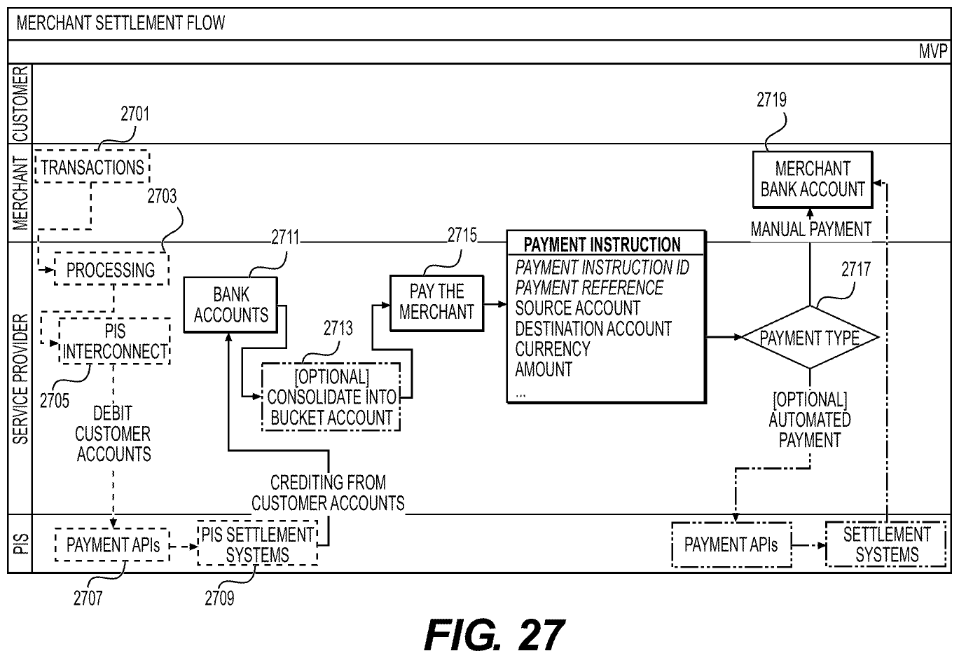

FIG. 27 depicts a merchant settlement flow for payment-related services, according to one example embodiment. Although the process is illustrated and described as a sequence of steps, it is contemplated that these steps may be performed in any order or combination and need not include all of the illustrated steps.

In step 2701, a customer may initiate a transaction with a merchant. Transaction processing system 109 may process the transaction (step 2703) and may aggregate the transactions per predetermined time period. In one embodiment, the aggregated transactions may include transaction ID, merchant ID, customer ID, amount, currency (ISO code), transaction date, transaction status, payment reference, etc. Transaction processing system 109 may transmit the aggregated transactions to a system of the third-party service provider (step 2705). Thereafter, transaction processing system 109 may send payment instructions to the payment API of PIS (step 2707). In one example embodiment, the payment instruction may include source account, destination account, currency, amount, etc. Transaction processing system 109 and payment API of PIS may debit the customer's current account for the transaction and may transfer the debited amount to the settlement account (step 2709).

Transaction processing system 109 and payment API of PIS may credit the bank account of the third-party service provider (step 2711). In one embodiment, transaction processing system 109 may consolidate the bank account of the third-party service provider into a bucket account (step 2713). Transaction processing system 109 may send payment instructions to transfer the amount of the transaction into the merchant's current account (step 2715). The payment instruction includes payment information, e.g., payment instruction ID, payment reference, source account, destination account, currency, amount, etc. The payment is deposited to the merchant's current account based on the payment type (step 2717). For example, automated payment is directly deposited from the settlement account to the merchant's current account (step 2719).

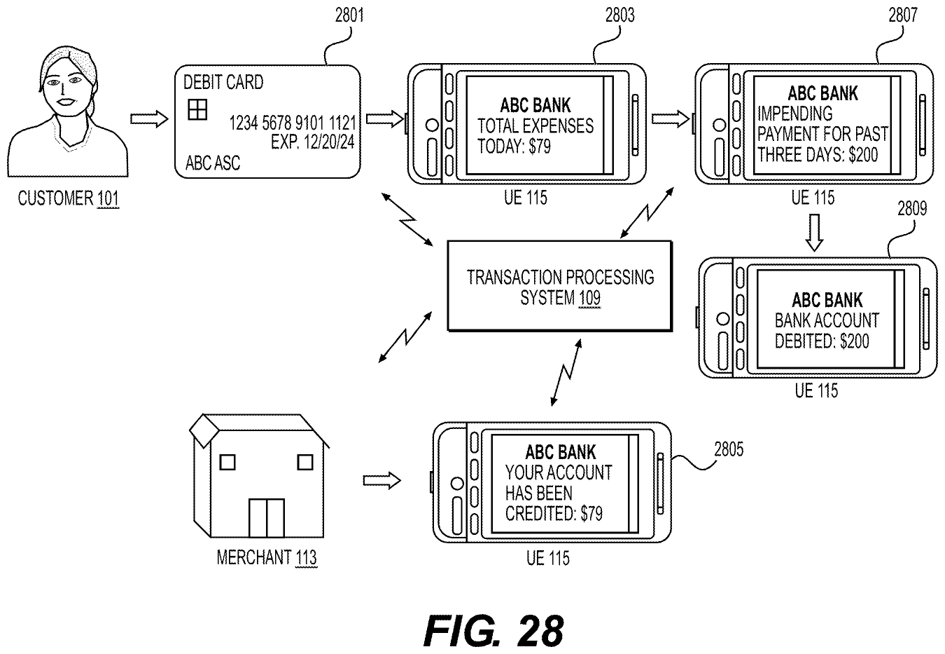

FIG. 28 is a diagram that illustrates a payment transaction session for a registered user and merchants to the transaction, according to various example embodiments. Although the process is illustrated and described as a sequence of steps, it is contemplated that these steps may be performed in any order or combination and need not include all of the illustrated steps.

In one example embodiment, customer 101 may use the train for daily commute, and taps her payment vehicle 103, e.g., debit card 2801, on the turnstile to enter the train station. Payment vehicle 103 is simply used as a customer identifier and to authorize the opening of the gates and is not used to pay for the train rides. Furthermore, customer 101 may incur other daily expenses, e.g., entertainment expenses, and swipes her payment vehicle 103 at the POS terminals of merchants registered with transaction processing system 109. Transaction processing system 109 may encrypt via an encryption protocol sensitive information of customer 101 at a reader head of the POS terminal. Transaction processing system 109 may identify a key and may decrypt the encrypted sensitive information for authentication of customer 101. Transaction processing system 109 aggregates the outstanding amount associated with the payment account of customer 101 based on a first preset time period, e.g., every 12 hours, every 18 hours, at the end of the day, etc. The aggregated outstanding amount is then displayed in user interface 2803 in UE 115 associated with customer 101, e.g., customer 101 is notified that she incurred a total expense of $79 today. Transaction processing system 109 may also notify customer 101 that the aggregated outstanding amount will be debited from her payment account on a second preset time period, e.g., in the next 3 days.

Transaction processing system 109 transmits the aggregated outstanding amount, e.g., $79, to a plurality of recipient accounts associated with merchants to the transactions. In one embodiment, such transmission of the aggregated outstanding amount is based on the first preset time period, e.g., the transmission may occur at the same time the aggregated outstanding amount is calculated. In another embodiment, the transmission of the aggregated outstanding amount is based on a pre-determined total outstanding amount threshold, e.g., the cost for the expenses in the payment account of customer 101 exceeds the maximum limit to overcome the first preset time period requirement. The transmitted payment for the outstanding amount is then displayed in user interface 2805 in UE 115 associated with merchant 113, e.g., merchant 113 is notified that a total amount of $79 has been credited.

Transaction processing system 109 then aggregates the transmitted payments based, at least in part, on a second preset time period, e.g., every three days. In one embodiment, the first preset time period is a subset of the second preset time period. The aggregated transmitted payment is displayed as user interface 2807 in UE 115 associated with customer 101, e.g., customer 101 is notified that a total amount of $200 is pending in her payment account for the past 3 days. Transaction processing system 109 deducts an amount that equals the aggregated transmitted payments, e.g., $200, from the payment account during the second preset time period, e.g., the 3 day time threshold. Thereafter, a user interface element 2809 is generated in UE 115 associated with customer 101, e.g., the consumer is alerted that $200 has been debited from her payment account.

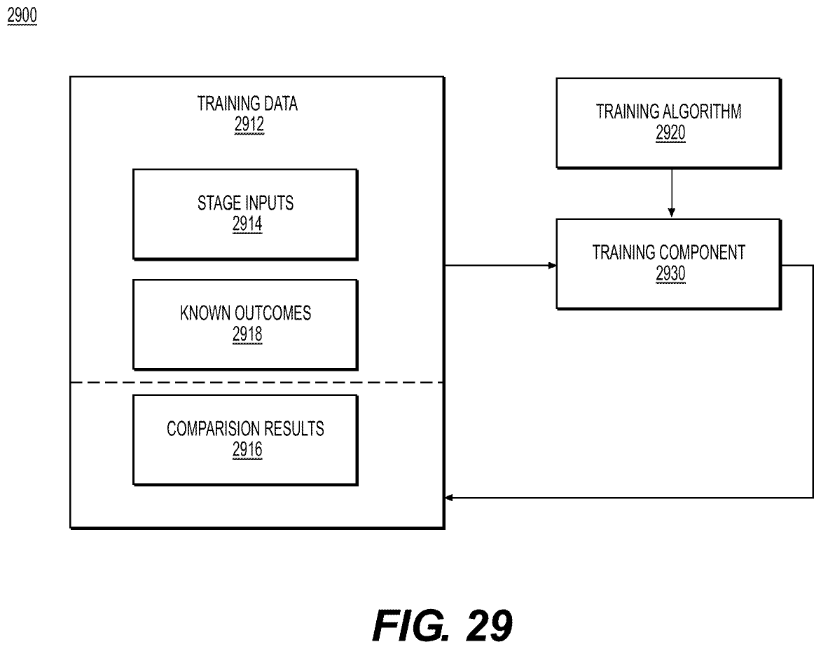

One or more implementations disclosed herein include and/or may be implemented using a machine learning model. For example, one or more of modules 201-213 and 301-325 may be implemented using a machine learning model and/or may be used to train a machine learning model. A given machine learning model may be trained using the data flow 2900 of FIG. 29. Training data 2912 may include one or more of stage inputs 2914 and known outcomes 2918 related to a machine learning model to be trained. The stage inputs 2914 may be from any applicable source including text, visual representations, data, values, comparisons, stage outputs (e.g., one or more outputs from a step of FIGS. 5A-5G). The known outcomes 2918 may be included for machine learning models generated based on supervised or semi-supervised training. An unsupervised machine learning model may not be trained using known outcomes 2918. Known outcomes 2918 may include known or desired outputs for future inputs similar to or in the same category as stage inputs 2914 that do not have corresponding known outputs.

The training data 2912 and a training algorithm 2920 (e.g., one or more of the modules 201-213 and 301-325 implemented using a machine learning model and/or may be used to train a machine learning model) may be provided to a training component 2930 that may apply the training data 2912 to the training algorithm 2920 to generate a machine learning model. According to an implementation, the training component 2930 may be provided comparison results 2916 that compare a previous output of the corresponding machine learning model to apply the previous result to re-train the machine learning model. The comparison results 2916 may be used by the training component 2930 to update the corresponding machine learning model. The training algorithm 2920 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

A machine learning model used herein may be trained and/or used by adjusting one or more weights and/or one or more layers of the machine learning model. For example, during training, a given weight may be adjusted (e.g., increased, decreased, removed) based on training data or input data. Similarly, a layer may be updated, added, or removed based on training data/and or input data. The resulting outputs may be adjusted based on the adjusted weights and/or layers.

In general, any process or operation discussed in this disclosure that is understood to be computer-implementable, such as the process illustrated in FIGS. 5A-5G may be performed by one or more processors of a computer system as described herein. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 30 illustrates an implementation of a general computer system that may execute techniques presented herein. The computer system 3000 can include a set of instructions that can be executed to cause the computer system 3000 to perform any one or more of the methods or computer based functions disclosed herein. The computer system 3000 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 3000 may operate in the capacity of a server or as a client user computer in a server-client user network environment, or as a peer computer system in a peer-to-peer (or distributed) network environment. The computer system 3000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 3000 can be implemented using electronic devices that provide voice, video, or data communication. Further, while a computer system 3000 is illustrated as a single system, the term “system” shall also be taken to include any collection of systems or sub-systems that individually or jointly execute a set, or multiple sets, of instructions to perform one or more computer functions.

As illustrated in FIG. 30, the computer system 3000 may include a processor 3002, e.g., a central processing unit (CPU), a graphics processing unit (GPU), or both. The processor 3002 may be a component in a variety of systems. For example, the processor 3002 may be part of a standard personal computer or a workstation. The processor 3002 may be one or more general processors, digital signal processors, application specific integrated circuits, field programmable gate arrays, servers, networks, digital circuits, analog circuits, combinations thereof, or other now known or later developed devices for analyzing and processing data. The processor 3002 may implement a software program, such as code generated manually (i.e., programmed).

The computer system 3000 may include a memory 3004 that can communicate via a bus 3008. The memory 3004 may be a main memory, a static memory, or a dynamic memory. The memory 3004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 3004 includes a cache or random-access memory for the processor 3002. In alternative implementations, the memory 3004 is separate from the processor 3002, such as a cache memory of a processor, the system memory, or other memory. The memory 3004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 3004 is operable to store instructions executable by the processor 3002. The functions, acts or tasks illustrated in the figures or described herein may be performed by the processor 3002 executing the instructions stored in the memory 3004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 3000 may further include a display 3010, such as a liquid crystal display (LCD), an organic light emitting diode (OLED), a flat panel display, a solid-state display, a cathode ray tube (CRT), a projector, a printer or other now known or later developed display device for outputting determined information. The display 3010 may act as an interface for the user to see the functioning of the processor 3002, or specifically as an interface with the software stored in the memory 3004 or in the drive unit 3006.

Additionally or alternatively, the computer system 3000 may include an input/output device 3012 configured to allow a user to interact with any of the components of computer system 3000. The input/output device 3012 may be a number pad, a keyboard, or a cursor control device, such as a mouse, or a joystick, touch screen display, remote control, or any other device operative to interact with the computer system 3000.

The computer system 3000 may also or alternatively include drive unit 3006 implemented as a disk or optical drive. The drive unit 3006 may include a computer-readable medium 3022 in which one or more sets of instructions 3024, e.g. software, can be embedded. Further, instructions 3024 may embody one or more of the methods or logic as described herein. The instructions 3024 may reside completely or partially within the memory 3004 and/or within the processor 3002 during execution by the computer system 3000. The memory 3004 and the processor 3002 also may include computer-readable media as discussed above.

In some systems, a computer-readable medium 3022 includes instructions 3024 or receives and executes instructions 3024 responsive to a propagated signal so that a device connected to a network 3070 can communicate voice, video, audio, images, or any other data over the network 3070. Further, the instructions 3024 may be transmitted or received over the network 3070 via a communication port or interface 3020, and/or using a bus 3008. The communication port or interface 3020 may be a part of the processor 3002 or may be a separate component. The communication port or interface 3020 may be created in software or may be a physical connection in hardware. The communication port or interface 3020 may be configured to connect with a network 3070, external media, the display 3010, or any other components in computer system 3000, or combinations thereof. The connection with the network 3070 may be a physical connection, such as a wired Ethernet connection or may be established wirelessly as discussed below. Likewise, the additional connections with other components of the computer system 3000 may be physical connections or may be established wirelessly. The network 3070 may alternatively be directly connected to a bus 3008.

While the computer-readable medium 3022 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 3022 may be non-transitory, and may be tangible.

The computer-readable medium 3022 can include a solid-state memory such as a memory card or other package that houses one or more non-volatile read-only memories. The computer-readable medium 3022 can be a random-access memory or other volatile re-writable memory. Additionally or alternatively, the computer-readable medium 3022 can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 3000 may be connected to a network 3070. The network 3070 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 3070 may include wide area networks (WAN), such as the Internet, local area networks (LAN), campus area networks, metropolitan area networks, a direct connection such as through a Universal Serial Bus (USB) port, or any other networks that may allow for data communication. The network 3070 may be configured to couple one computing device to another computing device to enable communication of data between the devices. The network 3070 may generally be enabled to employ any form of machine-readable media for communicating information from one device to another. The network 3070 may include communication methods by which information may travel between computing devices. The network 3070 may be divided into sub-networks. The sub-networks may allow access to all of the other components connected thereto or the sub-networks may restrict access between the components. The network 3070 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A method comprising:
receiving, in real-time, a plurality of transactions associated with an account of a registered user;
aggregating an outstanding amount associated with the plurality of transactions based, at least in part, on a first preset time period;
transmitting payments for the aggregated outstanding amount from a settlement account to an account associated with a merchant to the plurality of transactions based, at least in part, on the first preset time period, a pre-determined total outstanding amount threshold, or a combination thereof;
aggregating the transmitted payments based, at least in part, on a second preset time period;
transmitting an amount that equals the aggregated transmitted payments from the account associated with the registered user to the settlement account based, at least in part, on the second preset time period; and
generating a user interface element in a user interface of a device associated with the registered user, the merchant, or a combination thereof.

2. The method according to claim 1, further comprising:
receiving, over a communication network, access credentials of the registered user, wherein the access credentials include predefined values, a preset username and password, international mobile equipment identity (IMEI), an electronic serial number, a mobile equipment identity (ME ID), one or more identifiers unique to the device, or a combination thereof; and
authenticating the registered user based, at least in part, on verification of the access credentials.

3. The method of claim 2, further comprising:
integrating the account associated with the registered user, the account associated with the merchant, and the settlement account, wherein the integration is based on a consent from the registered user and the merchant; and
synchronizing, in real-time, transaction information for the plurality of transactions, the aggregated outstanding amount, the aggregated transmitted payments, or a combination thereof between the account associated with the registered user, the account associated with the merchant, and the settlement account.

4. The method according to claim 1, further comprising:
processing historical transaction information associated with the registered user to determine a probability of expenses in a next instance of time, wherein the historical transaction information includes past payment transactions;
determining the expenses for the registered user in the next instance of time exceeds account balance; and
determining one or more preset rules for the registered user based, at least in part, on the determination that the expenses in the next instance of time exceeds the account balance.

5. The method according to claim 1, further comprising:
processing historical transaction information to determine a credit ranking and a credit score for the registered user, wherein the historical transaction information includes credit history information, income information, debt-to-income ratio information, or a combination thereof; and
determining the first preset time period, the second preset time period, the pre-determined total outstanding amount threshold, or a combination thereof based on the credit ranking and the credit score.

6. The method according to claim 1, further comprising:
processing the account of the registered user to determine an account balance is below a pre-determined minimum balance threshold;
determining the aggregated outstanding amount exceeds the account balance; and
determining to transmit payments for the aggregated outstanding amount during the second preset time period based on historical transaction information of the registered user, wherein the historical transaction information includes a predicted income of the registered user, and wherein the predicted income is sufficient to settle the aggregated transmitted payments.

7. The method according to claim 1, further comprising:
determining a failure of at least one transaction from the plurality of transactions of the registered user;
processing the at least one transaction to determine a reason for the failure; and
generating a second user interface element in the user interface, wherein the second user interface element includes an alert on the reason for the failure of the at least one transaction.

8. The method according to claim 1, further comprising:
processing historical transaction information associated with the registered user, wherein the historical transaction information includes past payment transactions, shopping basket contents, or a combination thereof; and
determining a benefit program for the registered user based, at least in part, on the processing, wherein the benefit program includes a loyalty program, a coupon redemption program, a lottery program, or a combination thereof.

9. The method according to claim 1, wherein the account associated with the registered user and the account associated with the merchant are associated with same financial institution.

10. The method according to claim 1, wherein the user interface element includes a notification on crediting of the aggregated outstanding amount to the account associated with the merchant, debiting of the aggregated transmitted payments from the account associated with the registered user, or a combination thereof.

11. An apparatus for a payment-related service comprising:
at least one processor; and
at least one memory including computer program code for one or more programs,
the at least one memory and the computer program code configured to, with the at least one processor, cause the apparatus to perform operations comprising:
receive, in real-time, a plurality of transactions associated with an account of a registered user;
aggregate outstanding amount associated with the plurality of transactions based, at least in part, on a first preset time period;
transmit payments for the aggregated outstanding amount from a settlement account to an account associated with a merchant to the plurality of transactions based, at least in part, on the first preset time period, a pre-determined total outstanding amount threshold, or a combination thereof;
aggregate the transmitted payments based, at least in part, on a second preset time period;
transmit an amount that equals the aggregated transmitted payments from the account associated with the registered user to the settlement account based, at least in part, on the second preset time period; and
generate a user interface element in a user interface of a device associated with the registered user, the merchant, or a combination thereof.

12. The apparatus of claim 11, the operations further comprising:
receive, over a communication network, access credentials of the registered user, wherein the access credentials include predefined values, a preset username and password, international mobile equipment identity (IMEI), an electronic serial number, a mobile equipment identity (MEID), one or more identifiers unique to the device, or a combination thereof; and
authenticate the registered user based, at least in part, on verification of the access credentials.

13. The apparatus of claim 12, the operations further comprising:
integrate the account associated with the registered user, the account associated with the merchant, and the settlement account, wherein the integration is based on a consent from the registered user and the merchant; and
synchronize, in real-time, transaction information for the plurality of transactions, the aggregated outstanding amount, the aggregated transmitted payments, or a combination thereof between the account associated with the registered user, the account associated with the merchant, and the settlement account.

14. The apparatus of claim 11, the operations further comprising:
process historical transaction information associated with the registered user to determine a probability of expenses in a next instance of time, wherein the historical transaction information includes past payment transactions;
determine the expenses for the registered user in the next instance of time exceeds account balance; and
determine one or more preset rules for the registered user based, at least in part, on the determination that the expenses in the next instance of time exceeds the account balance.

15. The apparatus of claim 11, the operations further comprising:
process historical transaction information to determine a credit ranking and a credit score for the registered user, wherein the historical transaction information includes credit history information, income information, debt-to-income ratio information, or a combination thereof; and
determine the first preset time period, the second preset time period, the pre-determined total outstanding amount threshold, or a combination thereof based on the credit ranking and the credit score.

16. The apparatus of claim 11, the operations further comprising:
processing the account of the registered user to determine an account balance is below a pre-determined minimum balance threshold;
determining the aggregated outstanding amount exceeds the account balance; and
determining to transmit payments for the aggregated outstanding amount during the second preset time period based on historical transaction information of the registered user, wherein the historical transaction information includes a predicted income of the registered user, and wherein the predicted income is sufficient to settle the aggregated transmitted payments.

17. A non-transitory computer-readable storage medium carrying one or more sequences of one or more instructions for a payment-related service which, when executed by one or more processors, cause an apparatus to perform operations comprising:
receiving, in real-time, a plurality of transactions associated with an account of a registered user;
aggregating outstanding amount associated with the plurality of transactions based, at least in part, on a first preset time period;
transmitting payments for the aggregated outstanding amount from a settlement account to an account associated with a merchant to the plurality of transactions based, at least in part, on the first preset time period, a pre-determined total outstanding amount threshold, or a combination thereof;
aggregating the transmitted payments based, at least in part, on a second preset time period;
transmitting an amount that equals the aggregated transmitted payments from the account associated with the registered user to the settlement account based, at least in part, on the second preset time period; and
generating a user interface element in a user interface of a device associated with the registered user, the merchant, or a combination thereof.

18. The non-transitory computer-readable storage medium of claim 17, the operations further comprising:
receiving, over a communication network, access credentials of the registered user, wherein the access credentials include predefined values, a preset username and password, international mobile equipment identity (IMEI), an electronic serial number, a mobile equipment identity (MEID), one or more identifiers unique to the device, or a combination thereof; and
authenticating the registered user based, at least in part, on verification of the access credentials.

19. The non-transitory computer-readable storage medium of claim 18, the operations further comprising:
integrating the account associated with the registered user, the account associated with the merchant, and the settlement account, wherein the integration is based on a consent from the registered user and the merchant; and
synchronizing, in real-time, transaction information for the plurality of transactions, the aggregated outstanding amount, the aggregated transmitted payments, or a combination thereof between the account associated with the registered user, the account associated with the merchant, and the settlement account.

20. The non-transitory computer-readable storage medium of claim 17, the operations further comprising:
processing historical transaction information associated with the registered user to determine a probability of expenses in a next instance of time, wherein the historical transaction information includes past payment transactions;
determining the expenses for the registered user in the next instance of time exceeds account balance; and
determining one or more preset rules for the registered user based, at least in part, on the determination that the expenses in the next instance of time exceeds the account balance.
